(19) United States
(12) Patent Application Publication
(10) Pub. No.: US 2010/0218591 A1
(43) Pub. Date: Sep. 2, 2010

(54) METHOD AND APPARATUS FOR CONTROLLING RELATIVE COAL FLOW IN PIPES FROM A PULVERIZER

(76) Inventors: George W. Rhodes, Corrales, NM (US); Mark F. Carlos, Mercerville, NJ (US); Jeff Donahue, Rocky Hill, NJ (US)

Correspondence Address: IPUSA, P.L.L.C, 1054 31ST STREET, N.W., Suite 400, Washington, DC, 20007, US

(21) Appl. No.: 12/665,426

(22) PCT Filed: Jun. 4, 2008
(86) PCT No.: PCT/US08/06974

§ 371 Date: May 10, 2010

Related U.S. Application Data
(60) Provisional application No. 60/929,322, filed on Jun. 21, 2007.

(51) Int. Cl. G01N 29/14; F23N 5/26; G01N 29/30; G01F 1/20

(52) U.S. Cl. 73/1.82; 110/186; 73/587; 73/861.18

(57) ABSTRACT

Pulverizer coal flow pipes feed a mixture of air and coal to burners in electric utility coal fire facilities. A method and apparatus for sensing relative coal flow in the pipes uses acoustic emission (AE) sensors to detect flow in each pipe. Sensed relative flow in the pipes is used to balance flow in the pipes and to further adjust pipe coal flow. Sensed flow is used with control parameters of a furnace to maximize power plant efficiency and to ensure compliance with emissions requirements.

This application claims the benefit of U.S. Provisional Application No. 60/929,322, filed Jun. 21, 2007.

### BACKGROUND

1. Field of the Invention

This invention relates to control of coal flow from a plurality of pipes which are fed by a pulverizer to coal-fired burners such as are used in electric utilities. Control of relative coal flow in pipes emanating from a pulverizer is required in order to provide optimum combustion and compliance with emissions standards. Maintenance of balanced coal flow in pipes to burners of a furnace as used in the electric utility industry is desired.

2. Brief Description of the Related Art

The use of a pulverized air/coal mixture for firing power plants is known. Pulverizers grind coal having relative large particle sizes into smaller particle sizes and mix the particles with air. The output of a pulverizer is a high velocity, high volume of hot air containing coal particles. An air/coal ratio is maintained constant. Pulverizers have a plurality of pipes which connect the pulverizer to burners. It is desirable to provide even pulverized coal distribution to burners in a furnace or boiler. Even distribution allows lower excess air, increased boiler efficiency, reduced NOₓ, and improved emission compliance. Typical pulverizers have 4 to 7 pipes.

U.S. Pat. No. 4,512,200 to Ghering describes an apparatus for measuring relative flow of pulverized coal in a plurality of pipes connected between a common pulverizer and respective burners. Ghering recognizes that for each pulverizer, the magnitude of flow in each pipe need not be known. Instead, Ghering teaches that all that is required is the relative flow in the pipes from a single pulverizer. Ghering teaches detecting of pulverized coal particles utilizing electrostatic principles. A relative distribution meter based upon electrostatic principles is used to measure pulverized coal distribution to the plurality of burners associated with a given pulverizer. Electrostatic sensors are located at similar positions in each pipe. The electrostatic charge information is then integrated twice to obtain an average value to determine relative flow in each pipe. Insolated plate sensors may also be located on the pipe surface.

U.S. Pat. No. 4,674,337 to Jonas discloses a particle detector which utilizes an ultrasonic detecting probe which is inserted into a pipe. The probe has a flat surface inside of the pipe which is oriented to cause particles to impact at essentially the same angle. This patent teaches against the use of probes where sensitivity varies due to variation in impact angle. Transducers used by Jonas are provided by Physical Acoustics Corporation, Princeton, N.J., among others. The resonant frequency of the transducers is disclosed to be in the range of 100-900 kHz. It is an object of Jonas to provide an estimate of the total number and mass of the individual particles based upon classic physics where kinetic energy is equal to one-half mv². In Jonas, there is an attempt to measure the number and mass of individual particles born in a flowing stream of a predeterminable velocity. There is no disclosure that would suggest measurement in a single coal flow pipe, much less taking relative measurements by acoustic means and adjusting relative flow without actual monitoring of the number and mass of individual particles. Still further, Jonas requires measurement of a number and mass of individual particles flowing in a fluid stream of predetermined velocity. In the case of flow in pulverized coal pipes, the velocity is not predetermined, and instead is a function of other conditions such as a controlled air/coal ratio.

U.S. Pat. No. 5,571,974 to Nauful is directed to a method and apparatus for measurement of coal particle flow in a pipe. This detection system relies upon piezoelectric type sensors which are located both on the inside and the outside of a bend in a pipe. The ultrasonic detectors on the inside and the outside of the pipe provide inputs to a differential amplifier and the difference signal provides a vibration signal to determine a “net coal flow signal.” This patent discloses that the use of multiple sensors on a single pipe in combination with a differential signal is required. '974 discloses that there is a capability which allows balancing of the coal flow to the burners which requires that each channel of the coal flow measurement have the same relative output. The relative coal flow information will activate an alarm when coal flow to any burner is outside of an established norm.

Physical Acoustics Corporation, 195 Clarksville Road, Princeton Junction, N.J. 08550 manufactures and sells acoustic emission sensors, signal amplifiers, digital analysis hardware and software. Acoustical emission (AE) transducers rely upon the piezoelectric effect and incorporate at the AE transducer (sensor) low noise 40 dB preamplifiers integrated into the sensor housing for providing high sensitivity. This allows use of long cables which are often required for acoustic emission sensing. AE sensors “listen” to structures and materials to detect AE activity. This allows monitoring of structures and conditions for acoustic emissions allow monitoring of operating conditions.

The Physical Acoustics software allows for simultaneous monitoring of a plurality of AE sensors, provides for multiple wave form processing and provides for multiple simultaneous display. Instantaneous acoustic events such as a crack in a structure, or an article striking an object can be measured. Still further, the energy of acoustic emission can be measured by detecting all acoustic emission over a given time period (such as greater than 10 microseconds). The sensed energy is also referred to as energy counts, E, and is the measured area under the rectified signal envelope. AE signal magnitude quantity is dependent upon threshold setting and operating frequency. Total AE activity is often measured by summing the magnitudes of all of the detected events of all measured parameters. A duration time, D, is an elapsed time from the first threshold crossing to the last during measurement of energy counts, E. This time is measured in microseconds and depends upon source magnitude, structural acoustics, and reverberation. This is used for recognizing certain long-duration source processes.

Physical Acoustics software provides for display of counts of energy in histogram form and point plot of counts (or duration) versus amplitude. The true energy is a measure of AE hit energy. Absolute energy is derived from the integral of the squared voltage signal divided by a reference resistance (such as 10 K ohm) over the duration of the AE wave form packet. The duration may be 100 microseconds or greater. The range is from 0.000931 aJ to 1310.25 nJ. As a hit feature, this is a reporting of the true energy of the AE hit. As a time-based feature, it reports energy in the time/date driven data interval. As a time-driven feature, this is a parameter for monitoring continuous signals as it is independent of hit-based activity.

### SUMMARY

This invention relates to sensing of and control of relative coal flow in a plurality of pipes which connect a pulverizer to a burner in a combustion chamber. This type of combustion chamber is typically used in large electric utility boilers such as those manufactured by Babcock Wilcox. In order to assure complete combustion and compliance with pollution requirements, it is necessary that coal flow from the plurality of pipes be balanced, and that a ratio of air to coal (A/C) be maintained constant.

This invention relates to a method by which relative coal flow mass in individual pipes is measured. All coal-fired electric plants utilize pulverizers to grind large pieces of coal into fine particle sizes. Each pulverizer has several pipes through which coal is delivered (4 to 7 is typical) and each pulverizer provides a stream of hot air to a furnace where combustion occurs. The air/coal (A/C) mixture is critical to control costs, control efficiency of combustion, and reduce pollution such as particulate or NOₓ. If relative coal flow distributed between the pipes is not nearly equal, and A/C is not maintained undesirable results are produced which require costly maintenance. The undesirable results include, but are not limited to, burning division walls and burner tips, incomplete combustion/wasting of fuel and producing excess emissions. Measuring of the relative coal flow of particles at any given time in all pipes provides for control of the coal flow and combustion process.

In this invention, relative coal flow (not actual measured rates of coal flow) is sensed between the plurality of pipes emanating from a pulverizer and connected to a plurality of burners in a combustion chamber. Applicant has discovered that the known characteristic of the presence of “roping” of coal flow in a coal flow pipe can be used to improve determination of relative coal flow. In the past, attempts to measure coal flow have involved insertion of probes into a pipe, or other attempts to measure coal flow quantitatively. These methods try to avoid measurements in the region of coal flow because the “roping” otherwise interferes with this approach to measurement. In contrast, Applicant seeks to take advantage of the roping phenomenon. In one embodiment, this invention detects the energy of the coal flow in a region of “roping” by detecting acoustic emission from a piezoelectric transducer which is placed in the region of a pipe where roping coal flow impinges upon a pipe surface, such as at a bend. This invention utilizes AE sensors on different pipes and does not compare AE sensors located on a single pipe. AE sensors are attached at similar locations on each coal feeding pipe from a single pulverizer.

Roping occurs when solid particles of a dissimilar size conduct a conductive wall, thereby producing a static charge. The rope can be observed through a small window in a pipe, and is moving through the cylindrical pipe. However, because the rope is not stable in position or amount of material passing a given aperture at a given time, prior art attempted solutions to give reliable relative coal flow determination were not successful.

In the acoustic emission sensing of relative coal flow in pipes connecting a pulverizer to furnace burners, Applicant takes advantage of the presence of roping in the flow pattern. However, it is not absolutely necessary to have a roping condition present at the point of measurement. Measurements can be made at points where roping is not necessarily present as long as acoustic vibrations indicating acoustic energy are detectable. Applicant selects a position to ensure that a high speed particle stream should impact the wall of an elbow. This location is several meters distant from the pulverizer to enhance the probability of roping occurring because roping enhances the accuracy of measurement. The location of the AE sensors on each pipe should be at the same relative position. The location of the sensors, while not substantially sensitive, should be similar and on the outside elbow adjacent a burner wall of a furnace at a location where the pipe turns to go vertical. Maximum acoustic noise is generated on the outside of the bend, but identical signals are received on the inside of the bend indicating that the modes of transmission from particle impact are radial in nature. Signal degradation for an outside elbow location has been found to be only a few dB out of a 75 dB amplitude. A feature of AE sensors produced by Physical Acoustics Corporation is that the sensor includes a high gain amplifier which allows transmission of the AE data to a point several hundred meters distant. The definition of absolute energy is achieved by use of Physical Acoustics Corporation definitions and is key to obtaining the useful data. The acoustic emission data are always relative (not measurements of actual coal flow), and can be correlated to air/coal ratios at a given particle velocity. However, the measurements are always relative and never absolute.

The invention includes a method of controlling relative coal flow in pipes from a pulverizer to a burner comprising the steps of:

calibrating acoustic emission (AE) sensors;

placing an acoustic emissions sensor at a same relative position on each pipe;

sensing vibrations of each pipe with a sensor;

calculating an average of sensed vibrations of each pipe;

comparing the average of the sensed vibrations to the sensed vibrations of each pipe; and

adjusting coal flow in the pipes to be within a predetermined percentage of the average.

The invention includes a method for controlling coal flow from a pulverizer having a plurality of pipes which carry coal and air to a burner comprising the steps of:

measuring with calibrated vibration sensors acoustic energy (AE) vibrations produced by coal flowing in each of the plurality of pipes;

determining relative coal flow by comparing particle energy measurements of coal flow in the pipes; and

adjusting relative coal flow with a modulator located in at least one coal pipe.

The invention includes a method of providing a signal related to relative flow of coal particles in coal pipes comprising the steps of:

placing at least one acoustic emission (AE) sensor on an outside of a portion of first and second coal pipes having flowing particles impacting walls of the pipes;

detecting response of the at least one acoustic sensor to impacts while varying coal flow through the at least one pipe to acquire acoustic emission data for known coal flow rates, wherein the data is impacts per unit of time for a plurality of flow rates; and

correlating acoustic emission data of the impacts per unit of time and a measured flow rate with response of at least one acoustic emission sensor located on the first and second coal pipes to determine relative coal flow.

The invention includes a method of controlling balance coal flow in a plurality of pipes from a pulverizer comprising the steps of:

comparing outputs of a plurality of acoustic emission (AE) sensors wherein the sensors are on different pipes;

determining relative coal flow based upon difference of outputs of the plurality of acoustic emissions sensors;

taking corrective action to balance coal flow in the plurality of pipes by adjusting coal input, air flow and/or air/coal ratio.

### BRIEF DESCRIPTION OF THE DRAWINGS

FIG. 1 shows a pulverizer and combustion chamber and pipes connecting the two.

FIG. 2 shows a bend of a pipe with possible acoustic emission sensor locations.

FIG. 3 shows acoustic emission sensors and a main acoustic emission processor which has a plurality of inputs and output displays.

FIG. 4 shows the steps of a method for detecting coal flow and providing correction when a relative flow is out of tolerance.

FIG. 5A-5D shows measurement of acoustic emission signals from 16 pipes from four pulverizers in a power plant.

FIGS. 6A-6D show data which was used to validate sensors and imbalances.

FIGS. 7A-7D show a comparison of measurements when a mill C (pulverizer C) was shut down.

FIGS. 8A-8D demonstrate the effect when a blockage in a pipe of a mill (pulverizer) is experienced.

FIGS. 9A-9B show the effect of a blockage and removal of the blockage and return to normal air flow.

FIG. 10 shows the effect of a blockage on furnace (unit) emissions when a blockage occurs.

FIGS. 11A-11B show a case where acoustic emissions data in one pipe substantially differs from three other pipes.

FIGS. 12A-12D show how a change in flow of a single pipe effects the balance of a pipe (pipes) from a separate mill (pulverizer) all of which be a furnace (unit).

FIG. 13 shows a coal modulator which may be used to control flow in pipes.

FIG. 14A shows change in air/coal ratio in a test conducted at EPRI.

Similarly, FIG. 14B shows a constant velocity during the test where there was a change in air/coal ratio as shown in FIG. 14A.

FIGS. 15A-15D show measure energy of sensors at different positions in the test under the conditions shown in FIGS. 14A and 14B.

FIGS. 16A-16D show the same data as FIGS. 15A-15D but in a different format.

FIGS. 17A and 17B show a test where air/coal ratio (FIG. 17A) is held constant while the velocity (FIG. 17B) is changed.

FIGS. 18A-18D show the absolute energy versus time during the test of FIGS. 17A and 17B.

FIGS. 19A-19D show the absolute energy depicted in FIGS. 18A and 18D in a different format.

FIG. 20 shows a block diagram of a computer flow chart of a method of adjusting coal flow in individual pipes based upon a detected average.

FIG. 21 shows a block diagram of a computer flow chart of a flow control loop where flow in pipes is adjusted against a weighted average of emissions, NOₓ and other parameters from a utility plant.

### DETAILED DESCRIPTION OF EMBODIMENTS

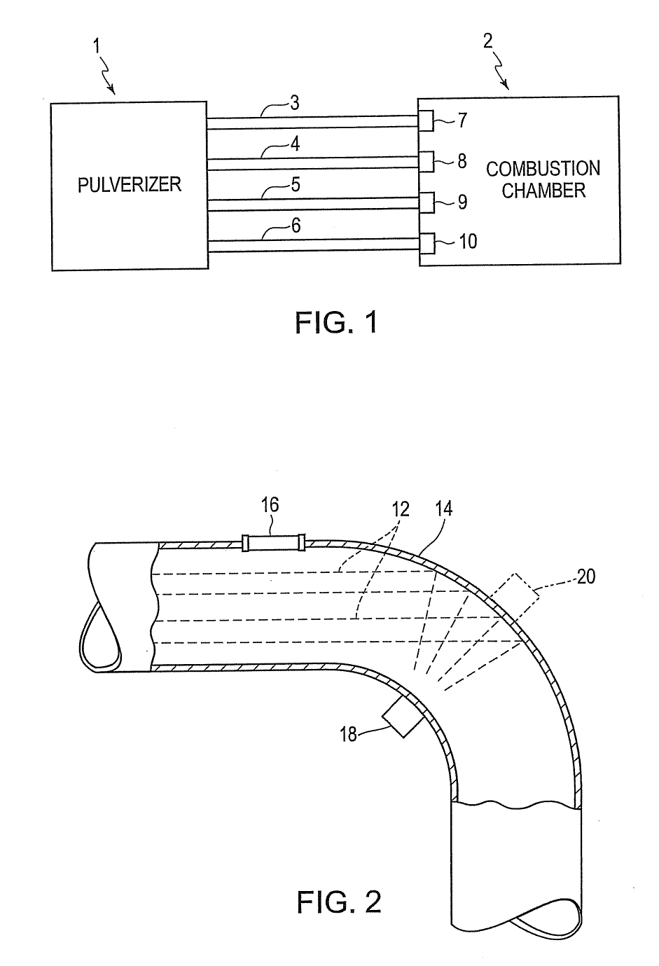

The overall configuration of a coal burning electric utility power plant combustion system is shown in FIG. 1. A pulverizer 1 provides ground coal particles and hot air at a velocity in the order of 37 meters per second to a combustion chamber 2. Typically, there are 4 to 7 coal flow pipes from each of a plurality of pulverizers 1 which feed a combustion chamber 2. The coal flow pipes 3-6 feed burners 7-10 respectively in a combustion chamber 2. There are typically a plurality of pulverizers 1 each feeding the combustion chamber 2 through a plurality of pipes. Usually the pipes from each pulverizer enter the combustion chamber 2 at the same height. Often, there are four pulverizers used to feed a combustion chamber through sixteen pipes.

FIG. 2 shows a detail of a pulverizer pipe such as pipes 3-6. Within a pulverizer pipe, particles 12 are depicted as dash lines. The dash lines indicate the phenomena of roping where the rope is separated from a pipe wall 14 by a distance which occurs due to static electricity charge within the pipe which urges the particles away from the side. The roping phenomena has been observed in pipes 14 such as by use of a window 16. As depicted in FIG. 2, when roping particles 12 strike a surface of a pipe at a location such as a bend, an acoustic emission sensor need only be located at a portion of the pipe 14 close to the point of impact of the rope 12 against a surface of the pipe 14. In FIG. 2, the acoustic emission sensor 18 is shown located on the inside of the pipe. However, the acoustic emission sensor 18 may be located on the outside of the bend such as location 20. It may also be anyplace else near where coal particles 12 strike pipe 14.

In the case where there are a plurality of pipes such as pipes 3-6 shown in FIG. 1, there will be a plurality of bends in the pipes which are a necessary consequence of constructing a coal burning electric utility boiler. Since it is an object of this invention to detect relative coal flow between the plurality of pipes 3-6, it is desirable that transducers 18 be placed at similar locations on each of the pipes where roping coal strikes a surface of the pipe. Typically, it is first established that there is a roping condition present in a pipe at a known location where coal particles impinge upon a pipe surface such as at a bend. Once it is established that similar locations in each of the pipes 3-6 are found, then transducers 18 are placed on each pipe at a same relative position with respect to the surface where coal impinges upon the pipe wall. It is not necessary to locate the transducers 18 at any particular location where coal flow is present. Typically, selection of position will merely require that the transducers be placed at a same position with respect to similar bends or positions on each of the pipes, such as at an inside of a bend or outside of a bend, or adjacent to a bend. This placement will necessarily be chosen in order that the determination of relative coal flow be consistent.

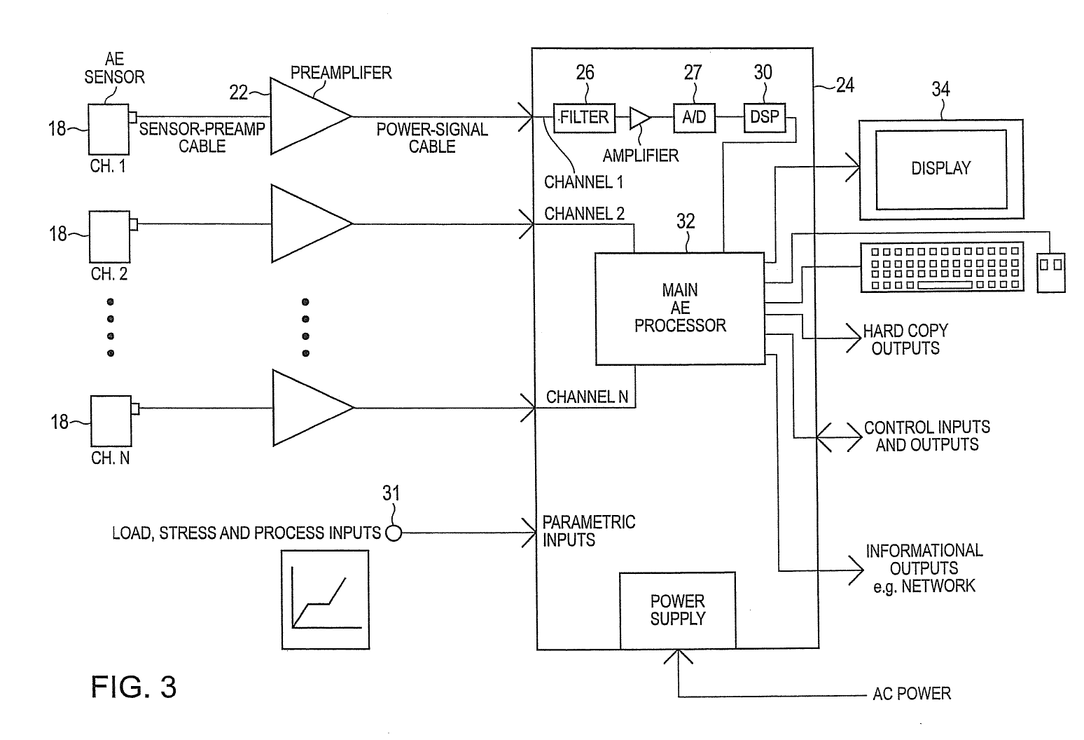

FIG. 3 shows a block diagram of an apparatus used for sensing coal pipe relative flow. AE sensors (R151-AST from Physical Acoustics Corporation) are located on each coal flow pipe connected to a pulverizer. The acoustic emission (AE) apparatus shown in FIG. 3 is produced by Physical Acoustics Corporation whose headquarters is at 195 Clarksville Road, Princeton, N.J. 08550. In each channel there is a preamplifier 22 which is a 40 dB amplifier located at the AE sensor 18. The preamplifier 22 enables the use of long power wire connections between the AE sensor and a multi-channel acoustic emissions system board 24. A channel is provided for each AE sensor. The board includes for each channel a filter 26 which may be used to filter out low frequencies or other frequencies produced in a power plant which are not relevant to coal flow detection. An analog-to-digital converter 28 and digital signal processor 30 provide the data to the main AE processor 32. The main AE processor processes signals simultaneously from each channel. In this invention, the main AE processor is used to detect the energy of particles of a coal rope impinging upon a wall of a coal flow pipe. The energy detected is related to the energy of coal impacts which are detected over a given period of time. The detection of energy is detecting of energy of collisions or impacts of the coal particles against the wall of the pipe.

These collisions and impacts create small high-frequency mechanical vibrations which travel along the coal feeding pipe (pipe). Each sensor on each pipe provides an output. The sensor converts the mechanical vibrations into electrical signals. The sensor is a piezoelectric crystal which is well-known in the art. The signals are then amplified and filtered by a preamplifier 22 and filtered by a filter 26. The AE data acquisition process filters out frequencies not related to coal impacts, amplifies and conditions the signal and converts the signal to a digital form in the analog digital converter. The digital signal processor 30 (DSP) extracts and processes wave form information and correlates the results with coal flow in order to extract information related to energy of impacts. The main AE processor 32 receives outputs of information from sensors 18 which are then used for control and monitoring of relative coal flow of pipes from a pulverizer. The display 34 may, for example, display four separate outputs each representing the output from an AE sensor 18 on a separate coal flow pipe 3-6. This data output allows operators to quickly visualize imbalance of the relative coal flow between the coal flow pipes. The system may also provide alarms and informational outputs used to monitor and control the process. Other parametric information 31 is provided.

The coal flow (delivery) pipes 3-6 are large in diameter (0.5 m) each having multiple 90° turns before the material is introduced into the combustion chamber 2 by way of the burners 7-10. The velocity of the air/coal mixture is fast (approximately 37 m/s). With this velocity, most of the entrained particles will contact (impinge) the walls of pipe during their passage to the furnace. Since the velocity of sound is approximately 5,000 m/s (in steel), a sensor is able to record hits (particle contact with the walls) over small distances (several m). Since a coal-fired plant is very noisy in the audible frequency range, detecting only high frequencies, such as those greater than 20 kHz is a reasonable low limit of a filter. Therefore, Applicant places a broadBand AE piezoelectric sensor (100-500 kHz) at a location along each coal pipe. During experiments, it was discovered that the transducer location can be on the inside of a pipe bend or the outside of a pipe bend or even in a straight pipe section which receives vibrations from impacts. During operation, it was observed that when the coal flow into the pulverizer was changed by 5% increments, the resulting acoustic signals on an individual pipe tracked the changes.

The reason that particles flowing in a “rope” pattern can be detected is that they are flowing at a high velocity, and their momentum causes them to strike the wall of a pipe such as at a bend. Stated another way, the momentum carries the particles to a wall of the pipe rather than navigating the bend with air without collision.

In a coal fired boiler burner where optimum efficiency of combustion and minimum emissions are desired, the air/coal ratio is held constant.

A/C=K₁

Since the amount of air (A) is a function of the velocity and cross sectional area of a pipe

A=VX

where X is the cross sectional area, and V is velocity.

Then, substituting V·X for A,

$$\frac{V \cdot X}{C} = {K}_{1}$$

Then

$$V = \frac{{K}_{1}}{X} \cdot C or {K}_{2} \cdot C$$

Then

V(1+ΔV)=C(1+ΔC)K₂

where ΔV is change of velocity and ΔC is change in coal. For example, if ΔV is 10%, ΔC is up by 10% because the air coal ratio is constant, then for example

V(1+0.01)=C(1+0.01)

but

$$\begin{matrix}E = \frac{1}{2} {MV}^{2} \\ = \frac{1}{2} C ( 1 + 0.1 ) \cdot {[ V ( 1 + 0.1 ) ]}^{2} \\ = \frac{1}{2} C ( 1 + 0.1 ) \cdot {{V}^{2} ( 1 + 0.1 )}^{2} \\ = \frac{1}{2} C \cdot {{V}^{2} ( 1 + 0.1 )}^{3}\end{matrix}$$

This shows that when A/C is constant that the energy of impacts is a function of the percentage change of the velocity cubed. This is also shown as

$$E = \frac{1}{2} {MV}^{2} = \frac{1}{2} M ( 1 + Δ M ) \cdot {[ V ( 1 + Δ V ) ]}^{2}$$

and if A/C is constant then

$$\% Δ M = \% Δ V$$

$$\begin{matrix}E = \frac{1}{2} M ( 1 + Δ V ) \cdot {[ V ( 1 + Δ V ) ]}^{2} \\ = \frac{1}{2} {{MV}^{2} ( 1 + Δ V )}^{3}\end{matrix}$$

This shows that the energy varies as the cube of the velocity when A/C is constant. This allows precise control of coal to the burner when relative velocity is modulated and relative energy of impacts in a plurality of pipes is observed.

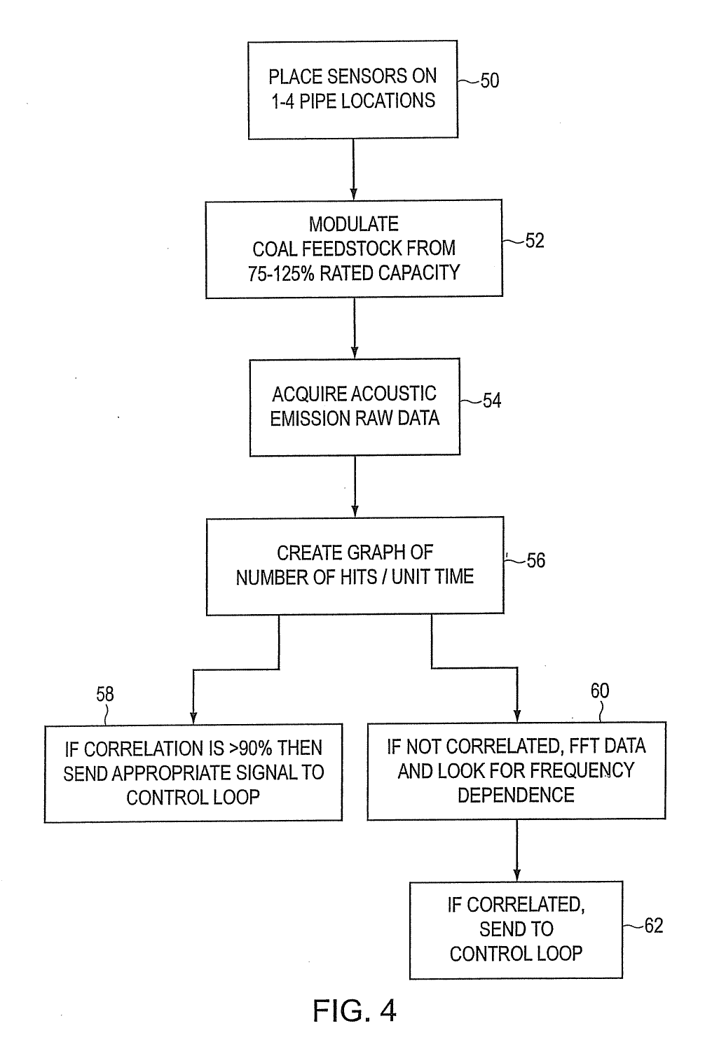

FIG. 4 is a block representation of a method and apparatus for detecting coal flow in pipes and providing correction of coal flow when relative flow is out of tolerance. In block 50 sensors are placed on each pipe at similar locations on different pipes. As shown in block 52, there was then modulation of coal feed stock from 75% to 125% of a rated capacity. This modulation provided for changes in coal flow which were then detected at block 54 as impacts/time at each sensor location. The sensing of impact/time is sensing of the energy produced by many impacts in a given time period. This sensing is provided by the use of piezoelectric sensors 50 and the Physical Acoustics Corporation hardware and software. At block 56, graphs are created of the number of hits per unit time (energy) sensed at each sensor location. At block 58, it was determined if a correlation of greater than 90% existed. Then if such correlation existed, appropriate signal data is sent to a control loop for controlling the coal flow in the pipe. At block 60, if it was determined that there was insufficient correlation (less than 90%), FFT (fast fourier transform) data is checked for frequency dependence. At block 62, it was determined that if correlation was present, then information could be sent to a control loop. In this example, plural sensors were used on each pipe to provide information to the control loop. The control loop may include other inputs such as NO and opacity. This loop can control the operation of the furnace and pulverizer. In determination of relative coal flow, the multiple sensors can be used in this manner with respect to each coal flow pipe, and the relative outputs of correlated sensors is then compared to determine the relative coal flow in the plurality of pipes.

However, it has been determined that only a single sensor need be used on each coal flow pipe because when the sensors are placed at the same relative pipe position the response is consistent. Accurate relative measurement between pipes is attainable without use of multiple sensors on each pipe. In order to achieve comparable relative coal flow in pipes using the multiple sensor approach of FIG. 4, it is still necessary that the sensors be placed on similar locations in each of the pipes connecting a pulverizer to a furnace.

In detecting relative coal flow between a plurality of pipes, the emission sensors at a key location (or locations) on the coal feed pipes provide detection of energy signals. The signals can then be compared to determine relative coal flow. The method of attaching piezoelectric acoustic sensors at key locations on coal feed pipes allows one to detect, record and quantify the collision of coal particles in each pipe for comparison in order to determine relative flow within the pipes. However, it is not necessary to measure the actual quantity of coal flowing in the pipe. The important consideration is merely the relative coal flow based upon like piezoelectric sensors located at similar locations on pipes feeding a furnace.

### Example 1

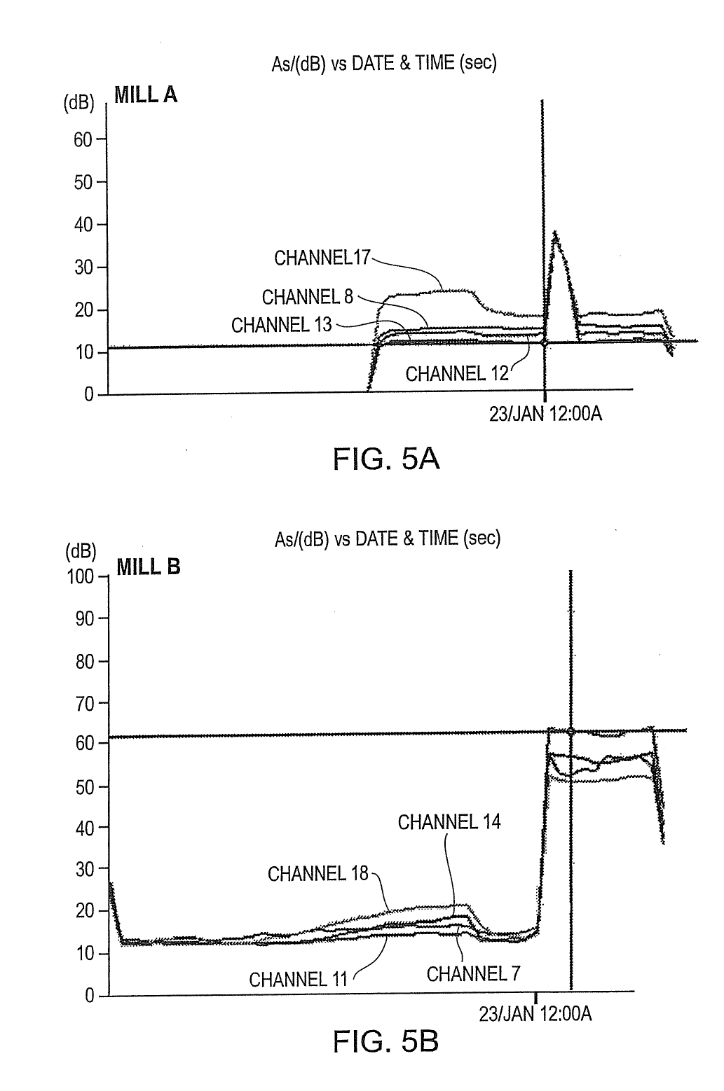

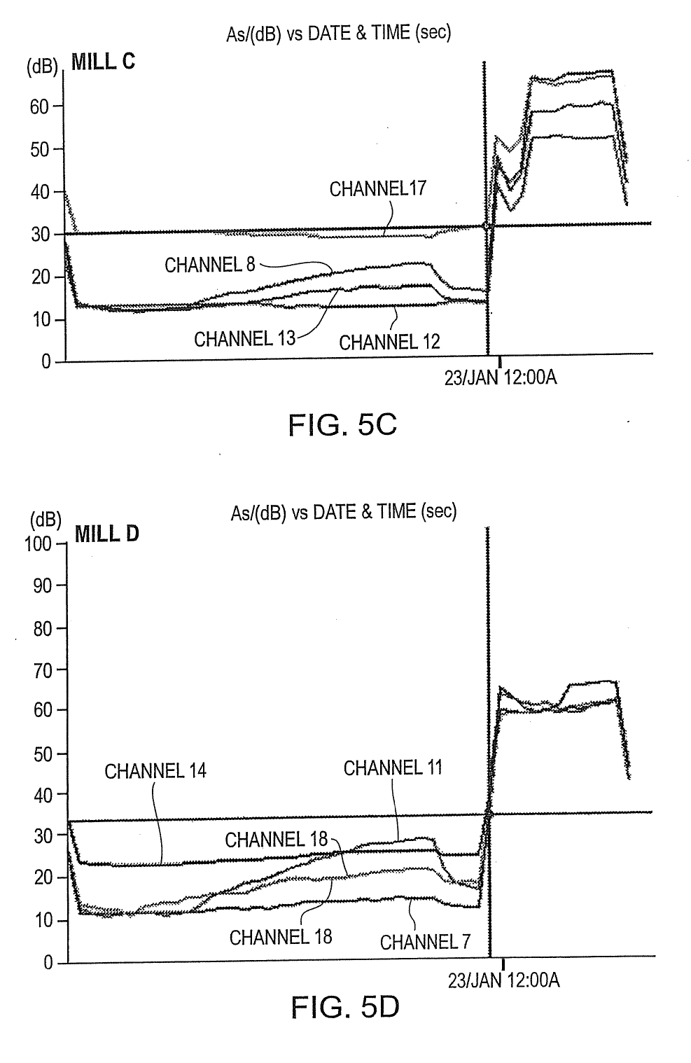

In the San Juan power plant, unit number 1, owned by Public Service Company of New Mexico (PNM), AE sensors were installed on all coal pipes. In all, there are 16 pipes from four pulverizer mills. The 16 pipes were remotely monitored for AE signals from 150 kHz to 300 kHz. The outputs of the four pulverizers as represented by the 16 pipes are shown in FIGS. 5A-5D. In these figures, the units are in dB and therefore the magnitude between 20 and 60 represents a factor of 10,000. FIG. 5A shows the measurements taken on single sensors located on each of the four coal pipes connecting mill A to unit 1. Similarly, FIG. 5B shows outputs of sensors connected to the four pipes from mill B, FIG. 5C shows the outputs of four sensors connected to pipes of mill C, and FIG. 5D shows the outputs of sensors connected to four pipes of mill D. All of the outputs shown in FIGS. 5A-5D represent the 16 pipes providing coal air mixtures to the San Juan unit 1.

In FIGS. 5A-5D, different channel numbers refer to sensor outputs from different pipes. The channel designation in all other graphs in this specification also refer to different pipes.

In FIG. 5A, the spike shows noise from the startup of unit 1 (the furnace). The tail is an artifact of signal averaging. FIG. 5D shows a period of time in which mill B pulverizer is not running. In FIG. 5C, there is shown the case where there is a serious imbalance in the mill C pipes where two pipes were carrying 80% of the coal while one has only 6% of the coal. This imbalance is clearly apparent from the difference in acoustic emission demonstrated in FIG. 5C. FIGS. 5A and 5D show that mills A and D have relative, even mass flow. This is seen in the graphs where the channel readouts are close in magnitude.

In FIG. 5A, the vertical line represents the time of starting the furnace.

In FIG. 5B, the vertical line represents a time stamp different than those shown on mills C&D and start of the furnace (Figs. A, C, and D).

In FIG. 5C, the vertical line represents start of mill C.

In FIG. 5D, the vertical line represents start of mill D.

### Example 2

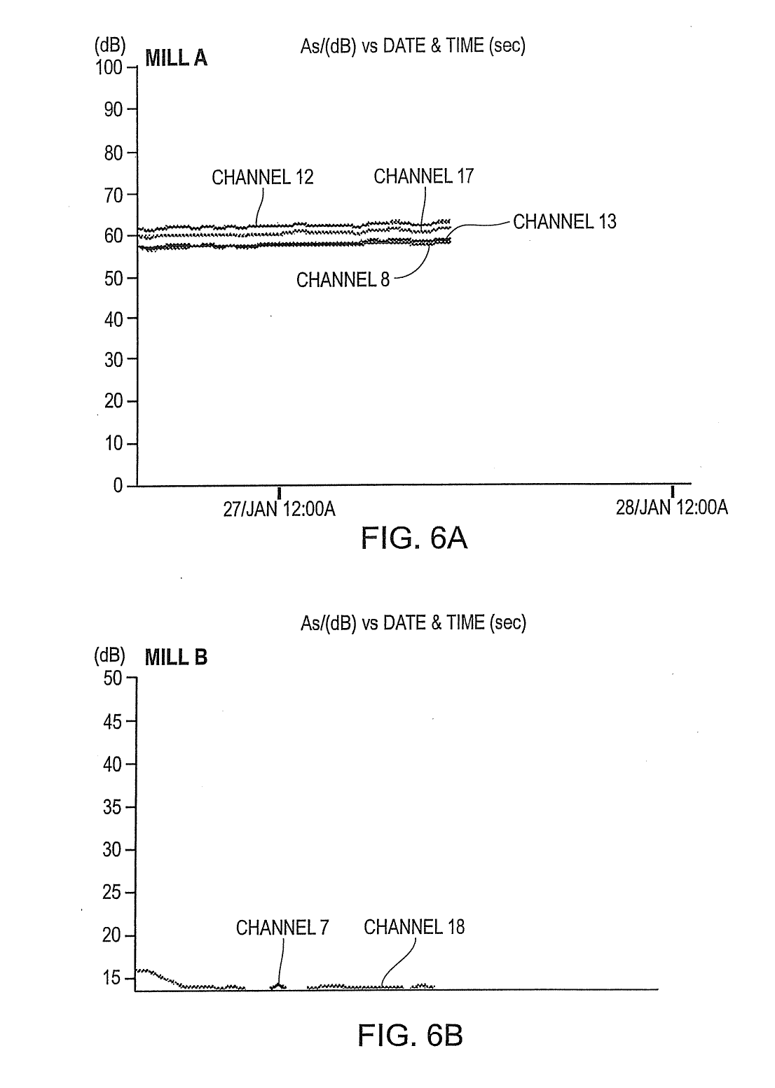

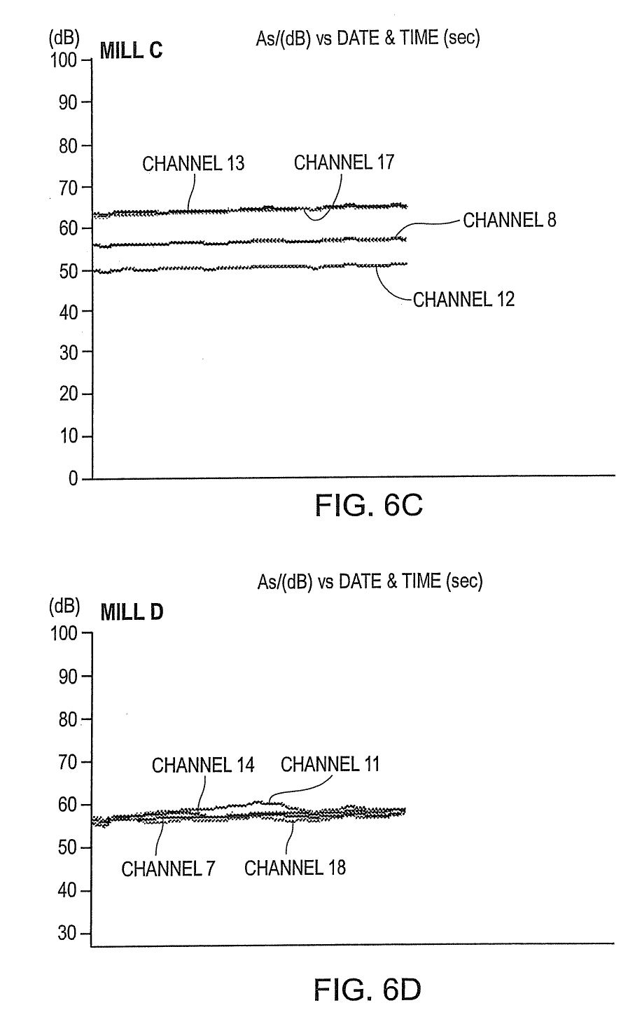

In FIG. 6A-6D, there is shown data which was taken to determine if the data were indeed valid data which could be relied upon. In the data, it is seen that there are apparent imbalances, and it was unknown whether the imbalances were real or the sensors were not mounted at positions which would yield correct relative data. To determine this, redundant sensors were attached to each location and it was found that the data seen was indeed correct.

### Example 3

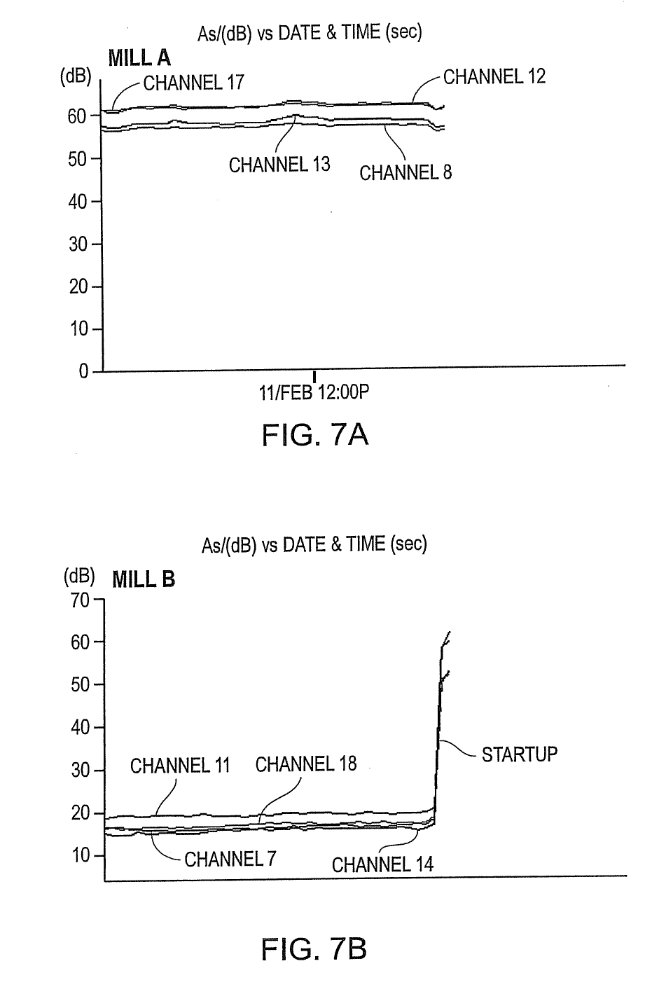

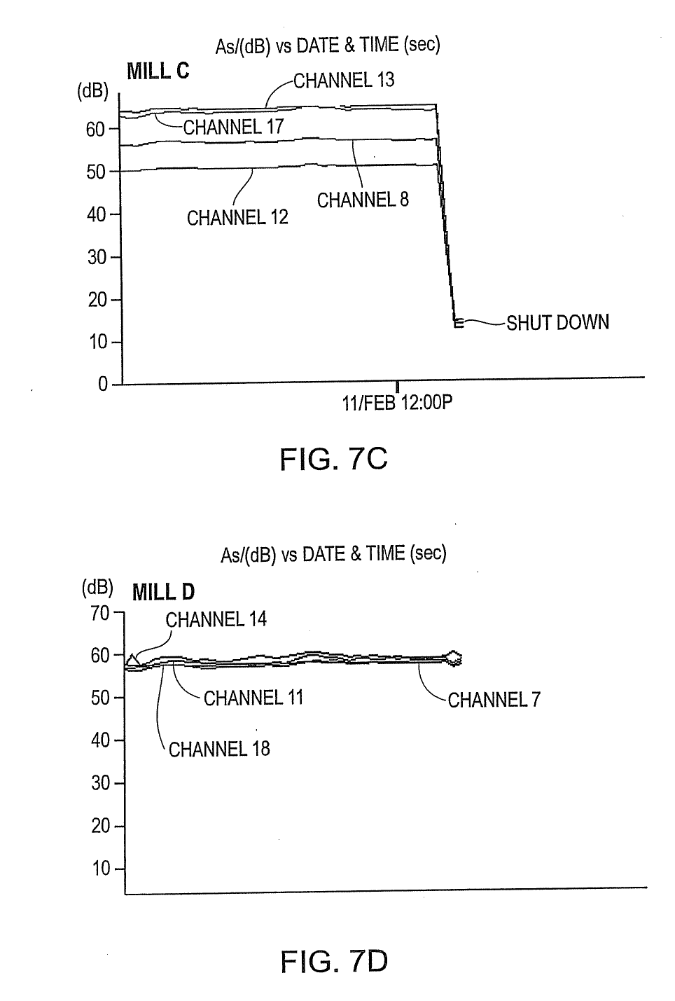

In FIGS. 7A-7D, measurements were taken when mill C (FIG. 7C) was shut down while at the same time mill B (FIG. 7B) was started up. These measurements show the comparative data in the four sets of pipes associated with each of the mills taken with single sensors attached to each of the 16 pipes associated with mills A-D.

### Example 4

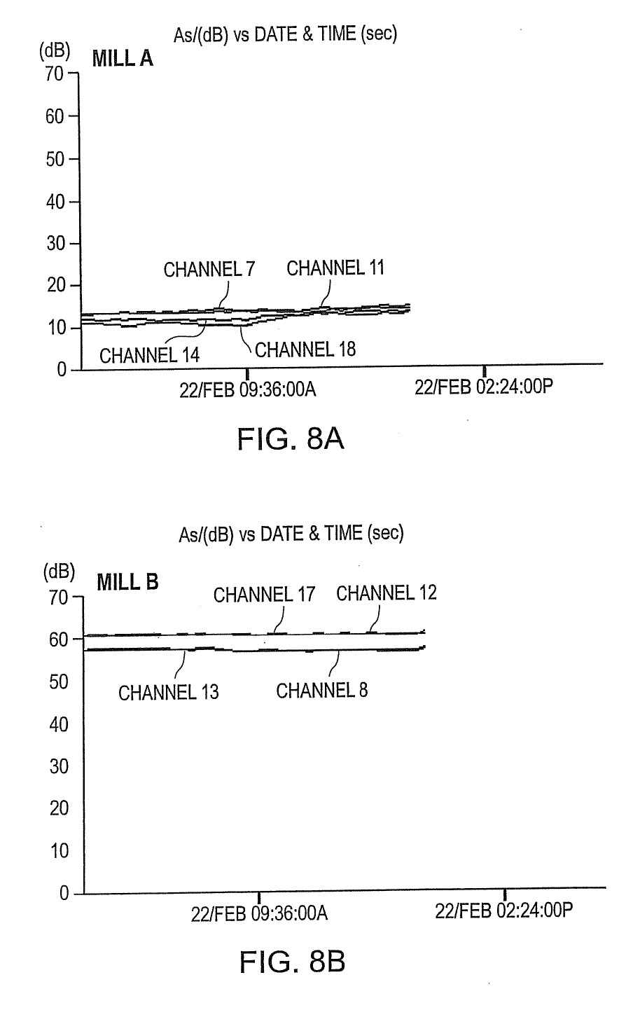

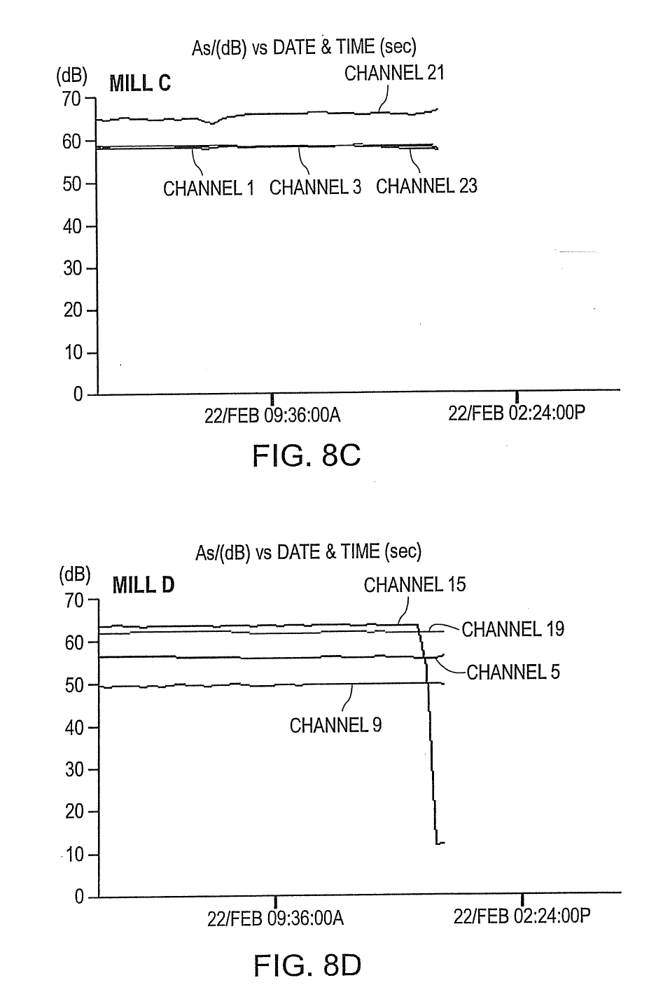

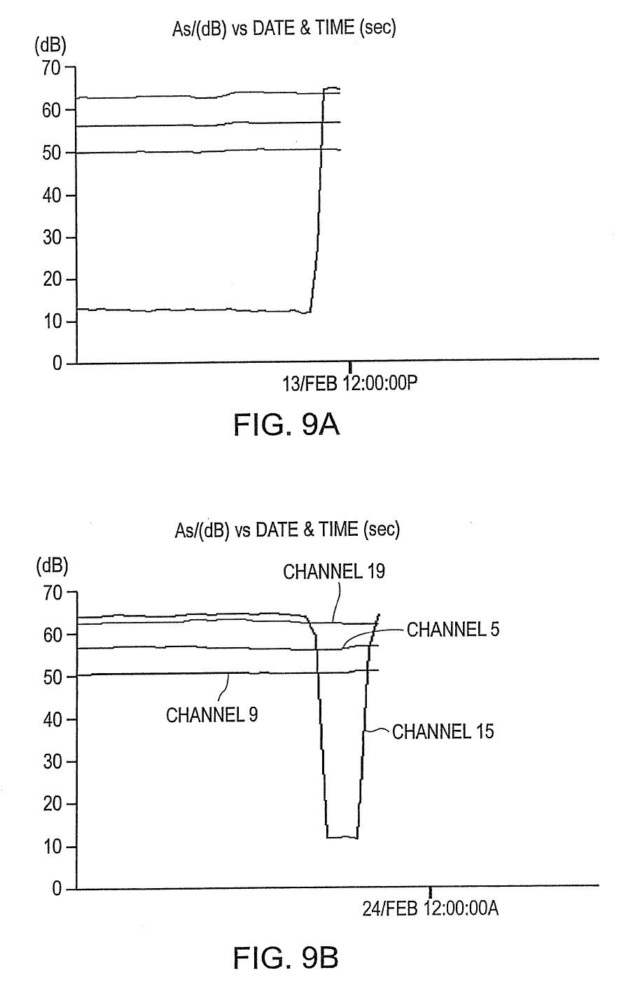

FIGS. 8A-8D demonstrate the observable effect in relative acoustic emission of the four pipes from each of mills A-D. The effect demonstrated here is the sensed output when a pipe blockage was experienced on a pipe C3 of mill D. This is shown in FIG. 8D where the acoustic emission energy from the pipe drops from approximately 64 dB to the ambient of 10 dB. During operation, as shown in FIG. 9A, the operator temporarily doubled the airflow to the system, and at this point, the blockage is removed and the system returned to a normal airflow as shown in FIG. 9A. The AE data informed the operator that a malfunction effecting compliance had occurred and where it was.

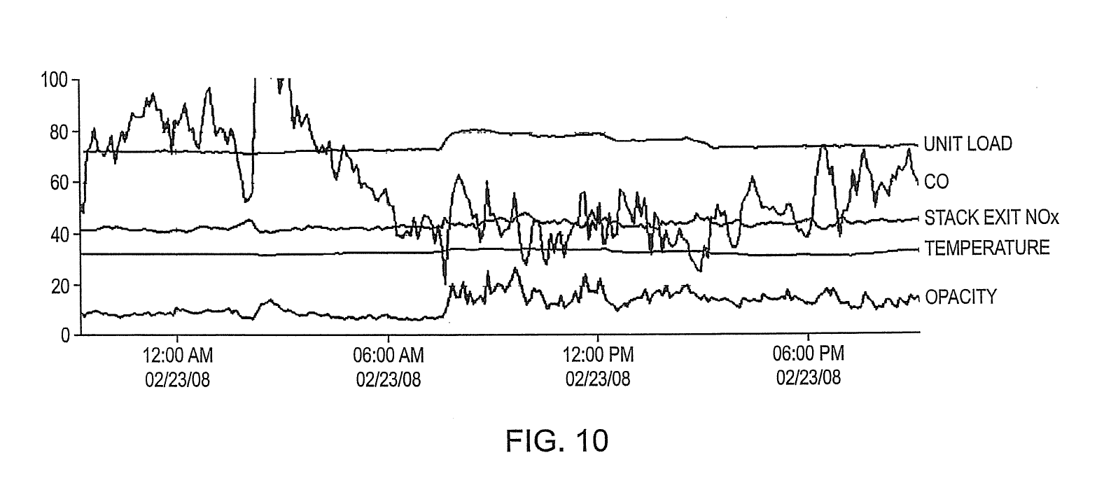

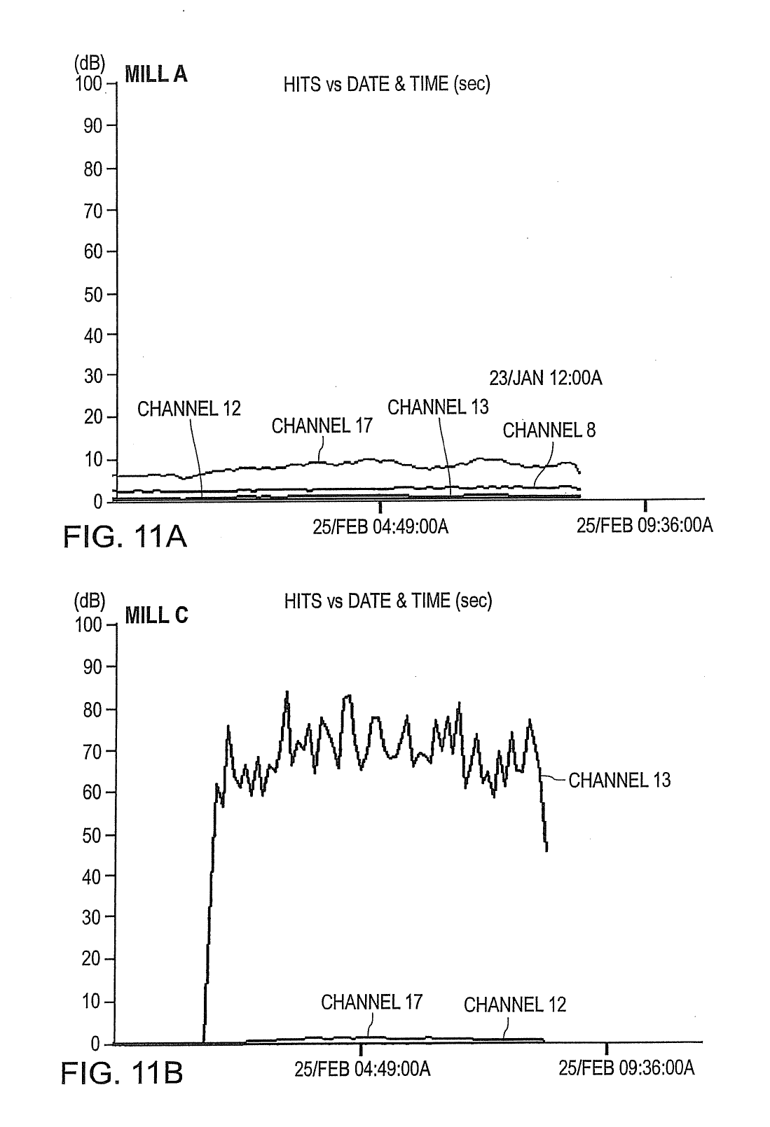

FIG. 9B shows that has blockage occurred and subsequent correction. This detection of blockage and the prompt provision for correction is critical and cost effective operation of a power plant furnace. When blockage occurs, there is a pronounced effect on opacity and NOₓ. When the pipe plugs, it sends the unit (furnace) out of compliance with required emission standards as shown in FIG. 10, and a statutory fine is incurred. A government fine occurs when an 11.6% limit is exceeded. It is therefore important to diagnose at the onset of such a condition and take remedial action if possible. This specific problem has caused PNM an excess cost of $1,000,000 in a single quarter.

Still further, by monitoring other acoustic emission information, PNM has found a clue to a recurring problem in the C3 pipe that experienced blockage. The hit rate data (acoustic emission data) was very different from this pipe. This is shown in FIG. 11 where the data in the C3 pipe substantially differs from C pipes 1, 2 and 4.

In this example, the plant engineering staff was able to determine that a fluttering BSO valve at the C3 pipe entrance would be causing the problem. This would explain why the pipe was becoming blocked, and that this pipe would be responsible for an opacity/NOₓ problem.

It was earlier reported that the B pulverizer showed similar patterns. In the case of the B pulverizer, the plant took the B mill offline and performed a clean air test where they observed that the BSO valves were working improperly. It was expected and determined that similar behavior would be found in the behavior of the C mill (C3 pipe). The BSO is a burner shut off valve which is a binary valve.

### Example 5

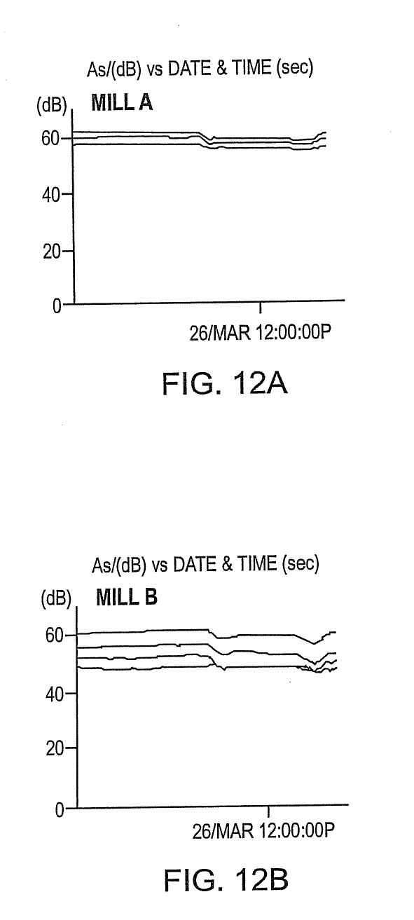

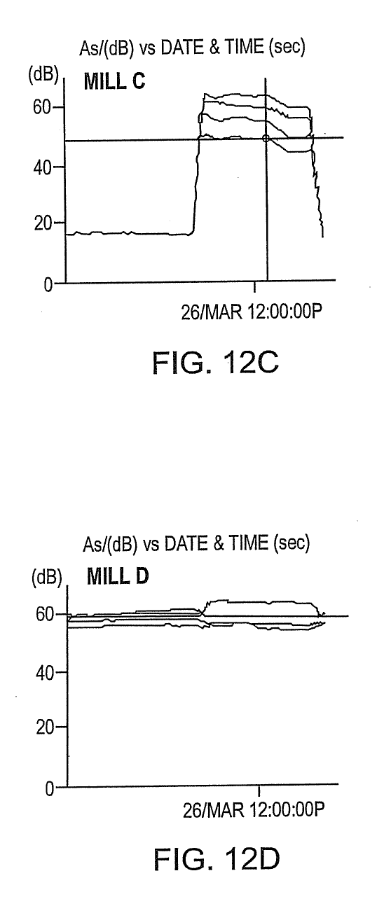

In a case of a multi-hour test in which C mill was defective, the ability to detect relative flow between all 16 pipes of a unit has proved to be very beneficial. In the case of a defective C mill, a test produced the unexpected result wherein the D mill, while normally operating as perfectly balanced, then showed an increased flow from a single pipe (D4) when the C mill was defective. This increased flow in a single pipe is observable in FIG. 12D. The defective mill C is shown in FIG. 12C and clearly has uneven relative flow in the four pipes. When the C mill was removed from operation, the D mill (FIG. 12D) returned to a normal balanced operation. This has shown that a defective mill feeding a unit may throw out of balance other mills connected to the same furnace unit.

Measurements taken have indicated relative coal flow in the four pipes, and have enabled correction of conditions such as pipe blockage and detection of variances of coal flow which placed the facility in out of compliance with pollution requirements.

### Coal Flow Modulator

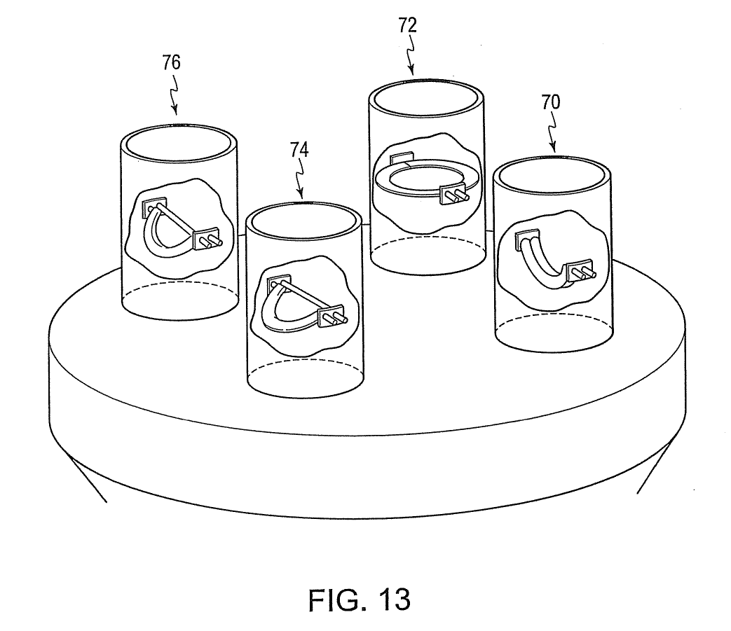

Control of velocity of air in a coal flow pipe is necessary to provide balanced coal flow from a mill. Siemens Power Corporation, Siemensalle 84 Karlsrahe, Germany 76187 supplies a coal flow modulator which is known as a PBG1 valve. FIG. 13 shows a schematic of coal pipe modulator positions wherein the four pipes have varying degrees of restriction which produces control of velocity. In FIG. 13, reference numeral 70 shows a pipe with maximum flow, pipe 72 shows a minimum flow, and pipes 74 and 76 show different degrees of restriction between minimum and maximum. With this type of variable restriction placed on pipes placed in a control loop with the relative coal measurements achievable by AE emissions sensing, a controllable relative flow of coal from a mill can be provided. Also the modulators all a control of the entire unit (furnace) operator.

### Pulverizers

Pulverizers used to feed burners in electrical utility furnaces are well controlled for the input of coal and air delivered, but their multiport outputs vary widely. Because single delivery sources are used for both coal and air the starting position is understood, but the number varies output streams (ports) between the four and seven depending upon the pulverizer manufacturer. The designs call for equal pipe flow to be delivered because the burner depends upon the A/C mixture (ratio) to be a defined value which may be two. If the A/C ratio at a specific burner elevation is uneven, the resultant flame can degrade burner tips and division walls of the furnace. Still further, reducing atmospheric fireside corrosion (occurring when insufficient oxygen is available for combustion) causes additional waterfall degradation. Often excessive fly ash deposition is observed on the water wall which indicates incomplete combustion. Each burner is fed by a single coal pipe. When the heat rate differs by as much as 10% from optimum, the burning of additional coal to meet the generation requirements is necessary. Additional environmental costs are also incurred when the heat rate is not correctly tuned. It is believed that the heat rates of many coal fired units is off by up to 10% due to improper flame stoichiometry. An improvement of flame stoichiometry therefore will allow substantial improvement in power plant operation.

It has been observed through mechanical probes (not relative coal flow sensed by acoustic emissions of this invention) that coal delivery pipes designed for 8.3 lbs./sec. actually vary between 1 and 30 lbs./sec. This clearly creates an environment where problems such as incomplete combustion and environmental costs are incurred. The losses incurred for excess coal consumption and environmental lines are a very high financial loss.

If the coal flow in pipes can be determined to within plus or minus 10%, then losses due to incomplete combustion and environmental costs can be greatly reduced.

In a typical coal fired generation facility, when the plant is new, the operations are the most reliable and predictable. However, as a coal fired generation facility ages, the wearing of components, and deviations from optimal heat rate will occur. This is considered normal.

### EPRI Testing

Simulated testing of determination of relative coal flow has been conducted at the EPRI funded coal flow test facility located in Livonia, Mich. This test facility uses a closed loop. In the test facility, coal surrogate particles (gypsum) are used because they resemble the particle size distribution usually seen from a pulverizer. An accumulator (hopper) stores the particles and a mechanical valve (auger) delivers precise amounts of gypsum into a controlled air velocity. This facility employs numerous sensors to measure the air/solid particle ratio and mass of gypsum separately. The acoustic emission sensors (AE sensors of this invention) were tested at this facility. The AE sensors were manufactured to measure frequencies from 50-400 kHz. This eliminated the possibility of ambient (low frequency) harmonics from obscuring the acoustic emission data sought. The acoustic emission data sought was relative energy of the particles flowing in the pipe.

In order to determine the criticality of sensor placement on a pipe, four positions on a pipe were selected. Position 1 was on a straight pipe section before any roping occurred. The lack of roping was confirmed by use of a transparent section immediately preceding the location of position 1 and visual observation revealed uniform particle flow across the pipe. Position 2 was on the center of an outside radius of a 90° elbow. Position 3 was on the inside radius of the same elbow. Position 4 was on an outside radius of a 90° elbow well downstream from the first 90° elbow.

### Test 1

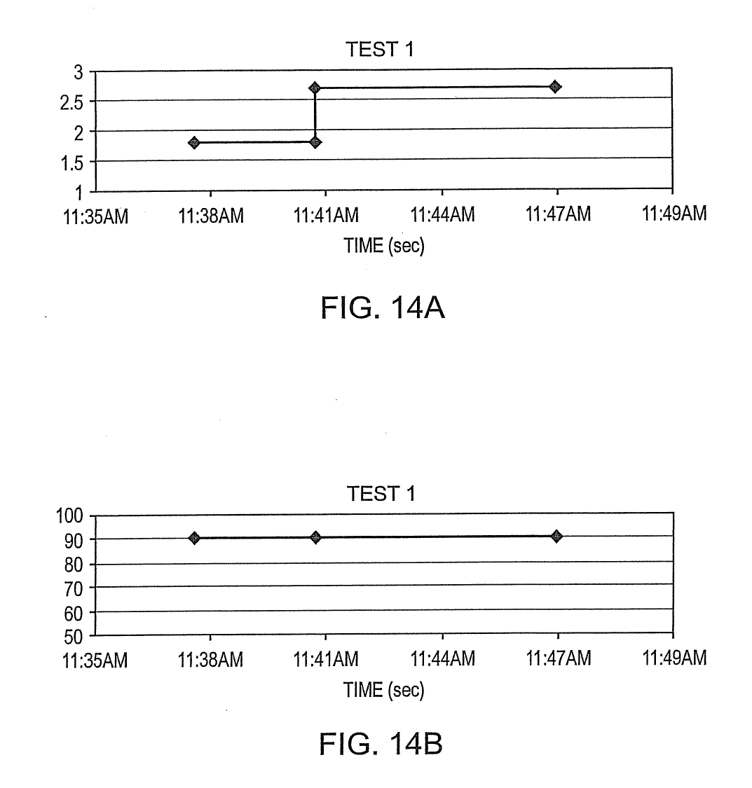

In test 1, conducted at the EPRI facility, velocity was held constant as shown in FIG. 14B. On the other hand, the A/C ratio was increased from 1.75 to 2.75 as shown in FIG. 14A. The increase in A/C ratio reduced the amount of coal flowing in the pipe, which makes the burner run lean. Gypsum is substituted for coal.

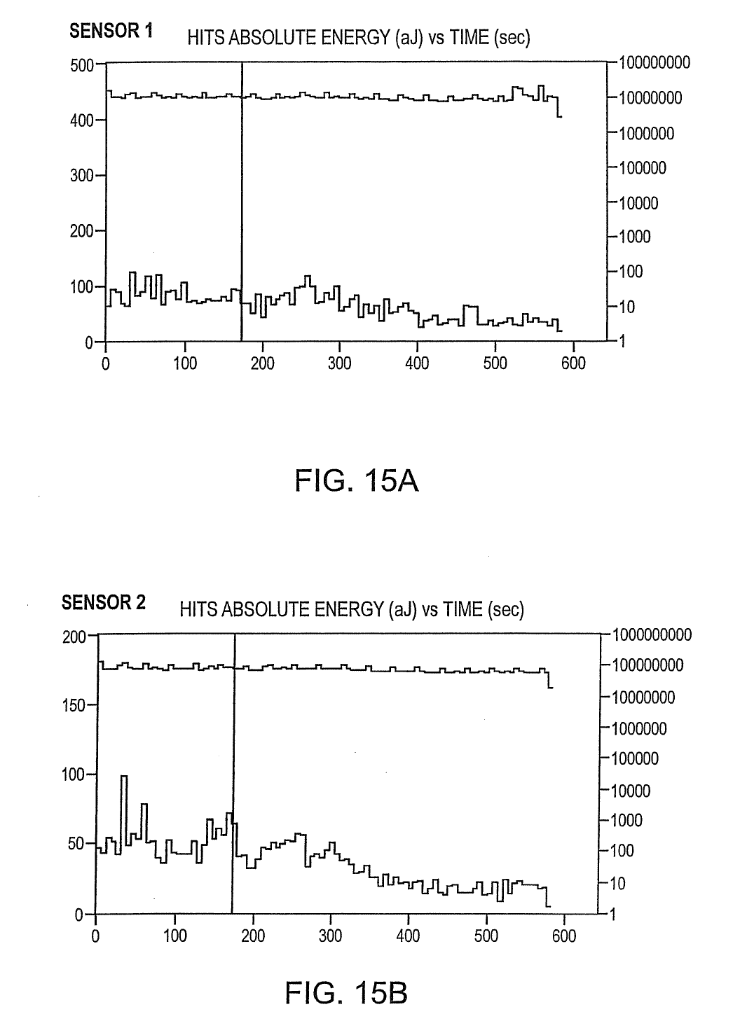

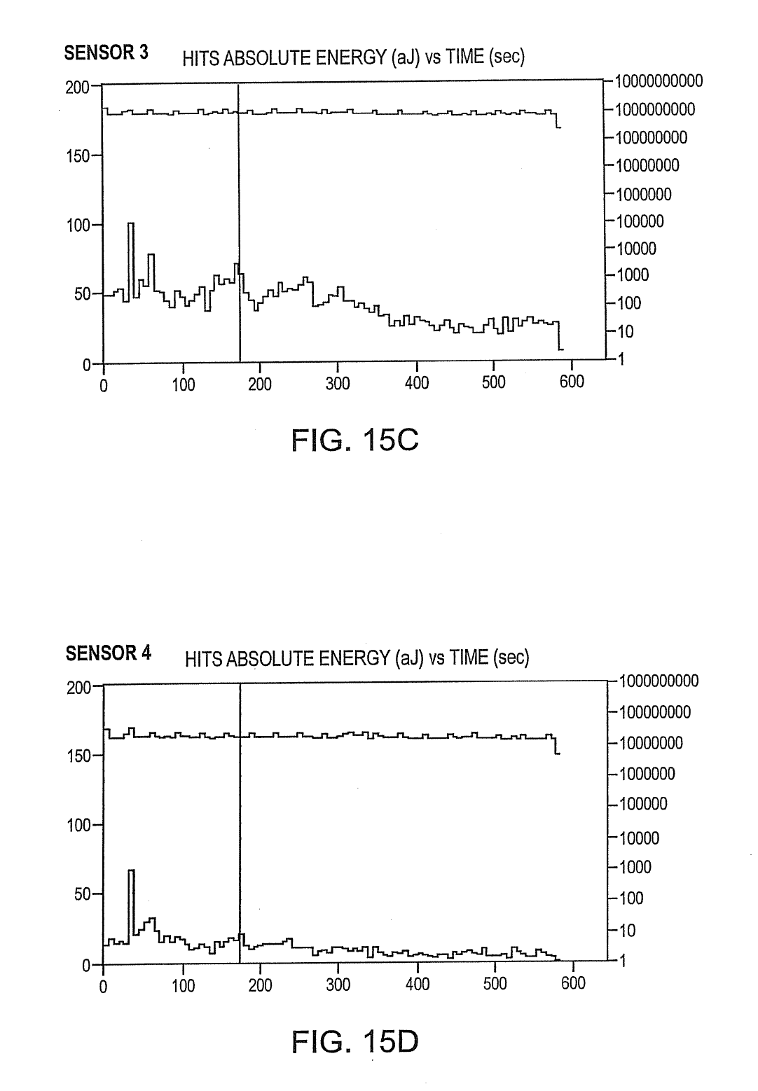

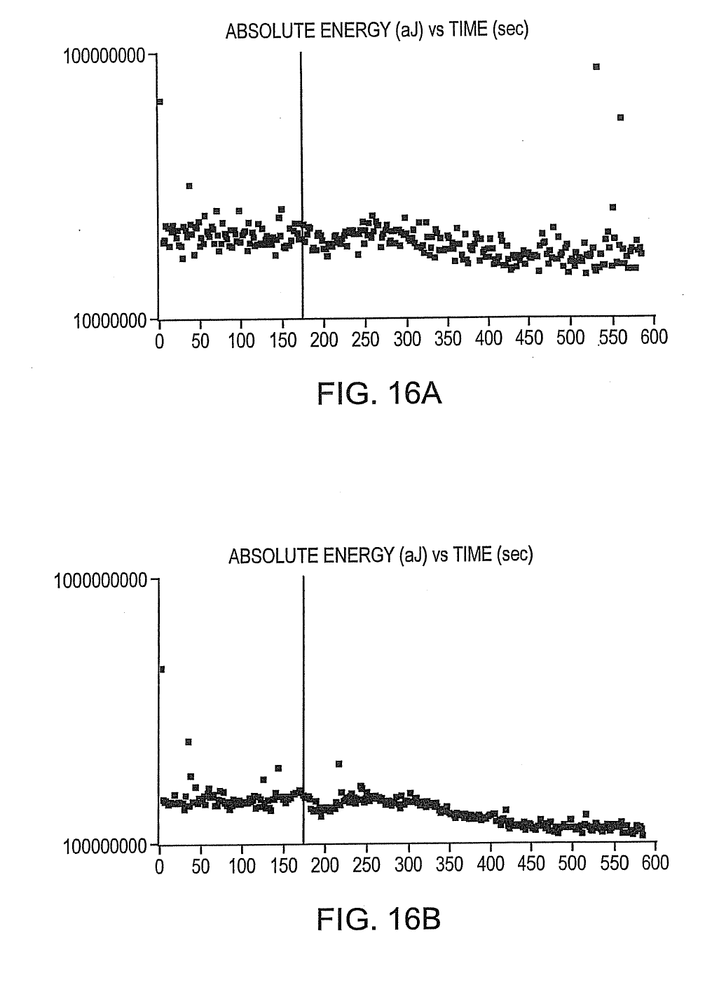

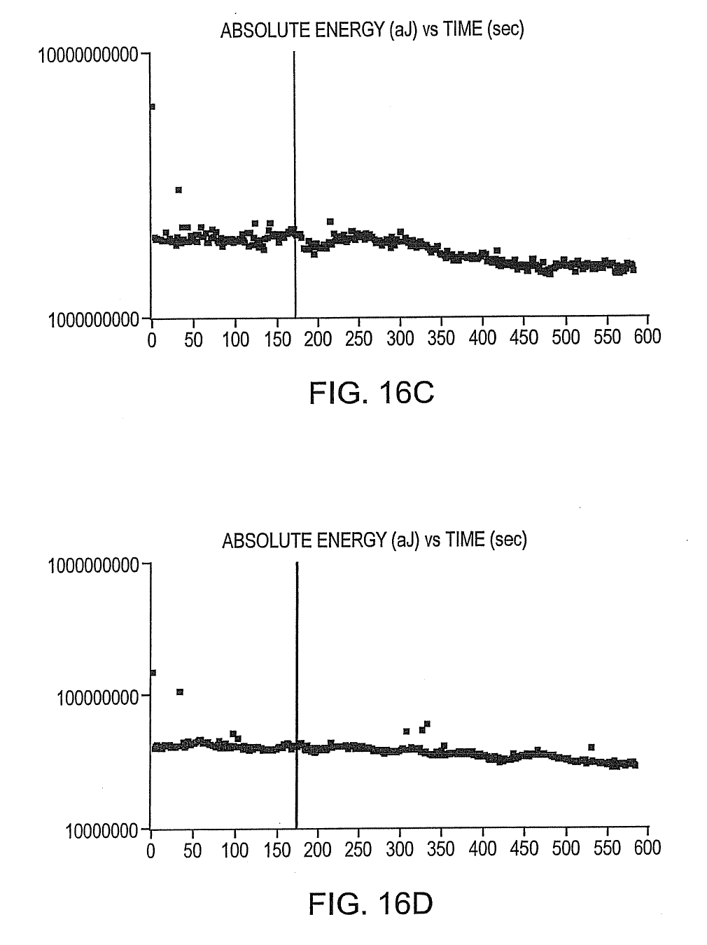

The AE hits absolute energy versus time was then measured for each sensor location. FIG. 15A shows measured energy for sensor 1. 15B shows measured energy for sensor 2. FIG. 15C is measured energy for sensor 3, and FIG. 15D shows measured energy for sensor 4. FIGS. 16A-16D show the acoustic emission data from the sensors 1-4 in a different format available through software and displays provided by Physical Acoustics Corporation. The vertical time mark shown in FIGS. 15 and 16 corresponds to the change in A/C ratio shown in FIG. 14A. After somewhat less than three minutes, the AE sensors 2 and 3 (located on the outside and the inside of the first 90° elbow) came to a steady state where the number of hits (wall impacts creating a response above the threshold) declined to about 66% (1.75/2.75) of the starting value. It was determined that this result is entirely consistent with a linear phenomena taking into account a decrease in roping.

The graphics shown in FIG. 15 represent total energy per sensor and are on a logarithmic scale.

The results depicted in FIG. 15 and FIG. 16 are identical. The result in FIG. 16 is also logarithmic.

### Test 2

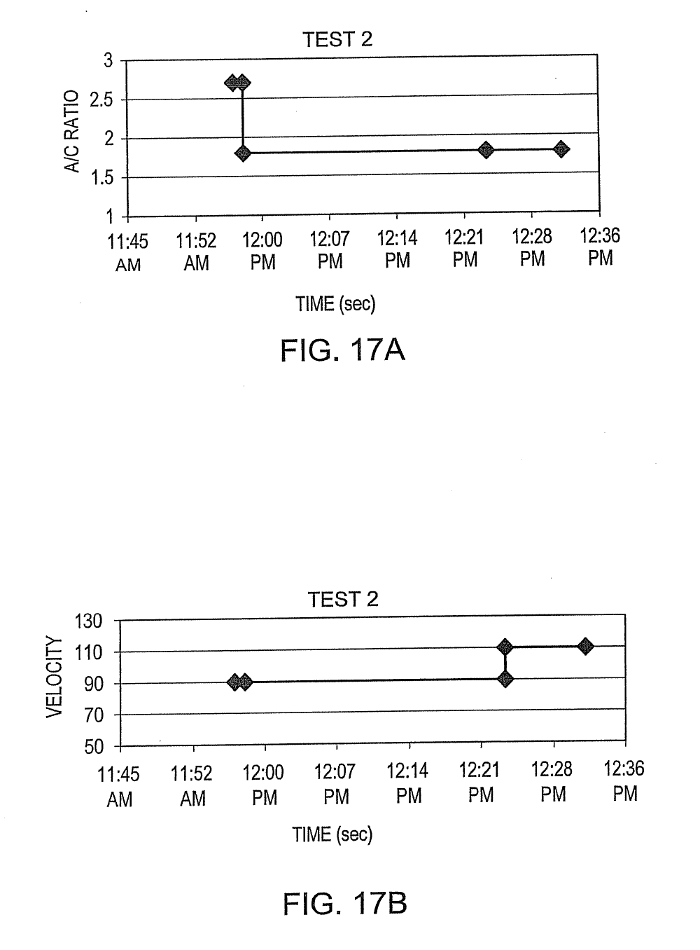

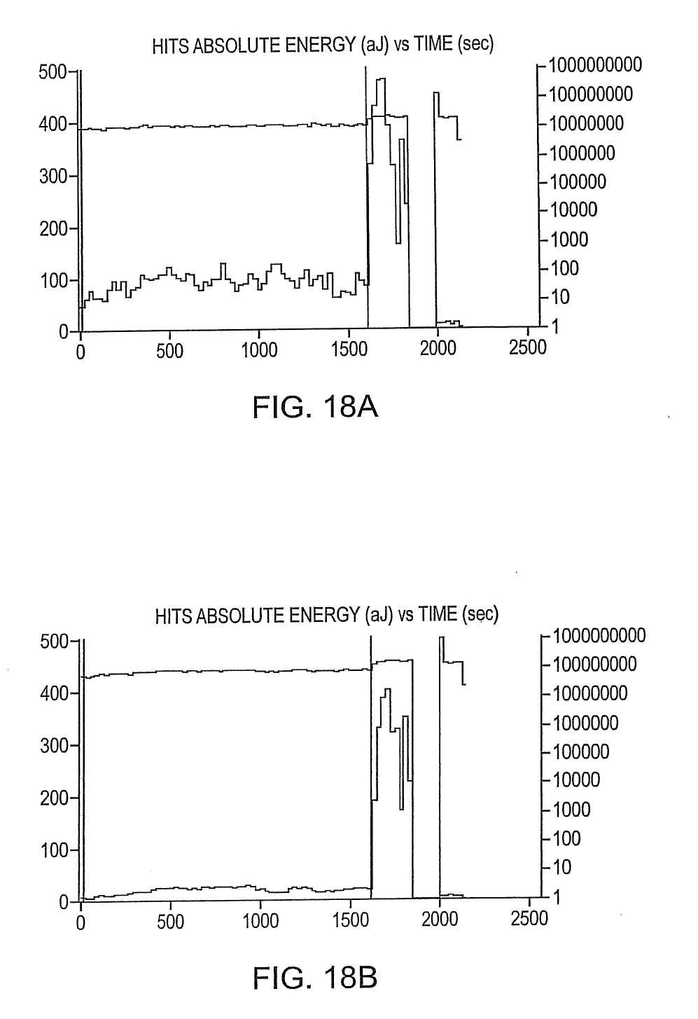

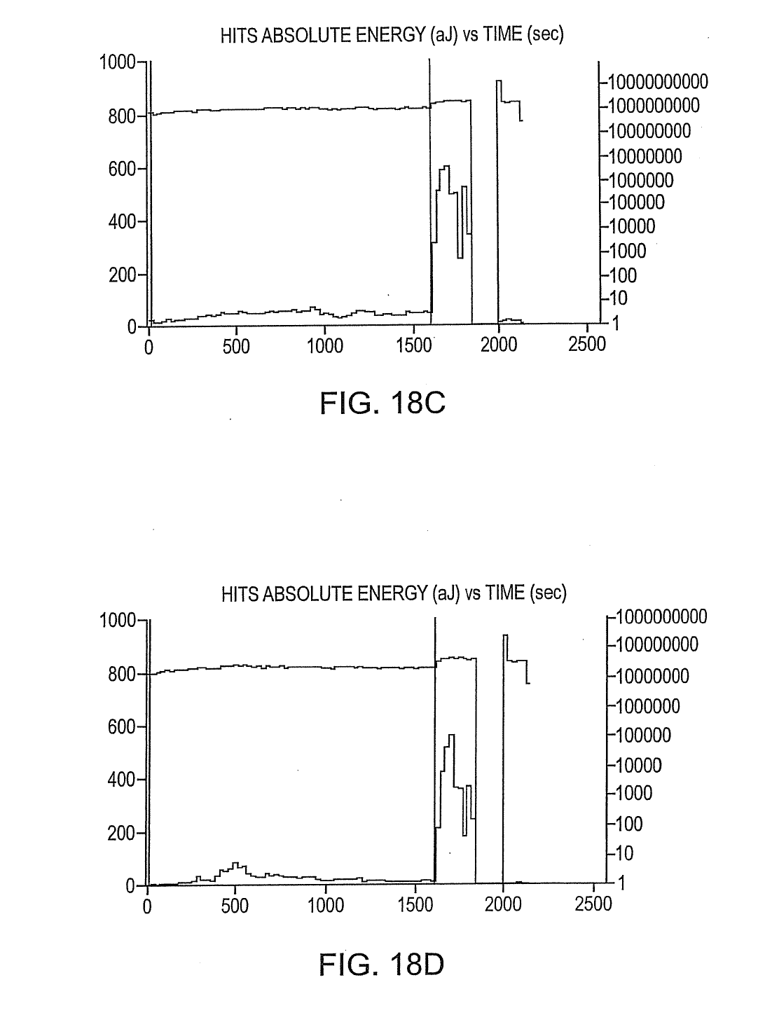

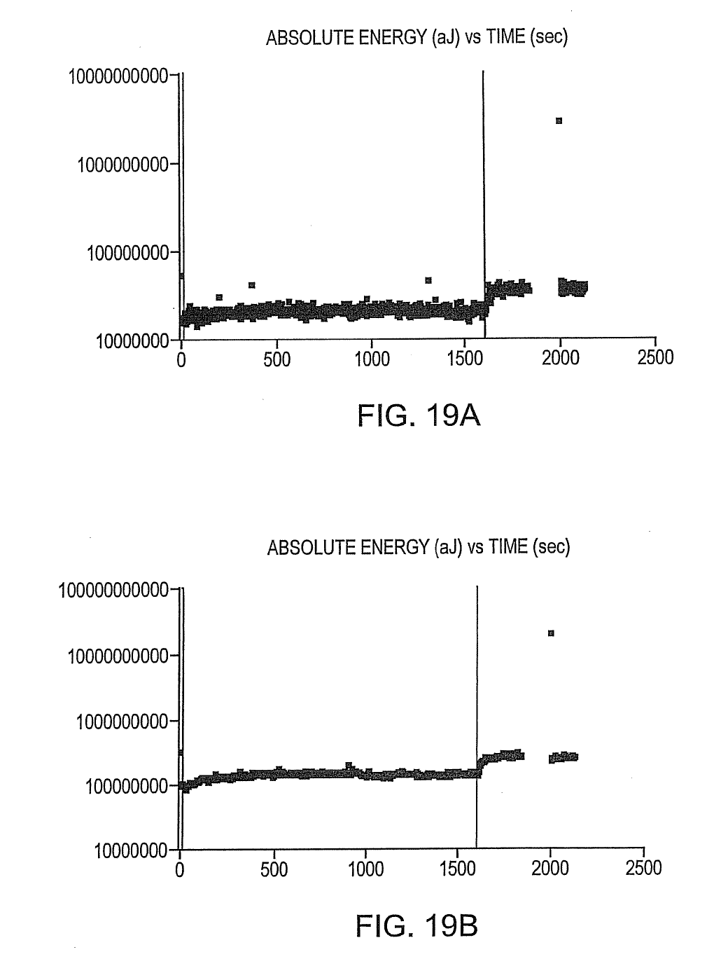

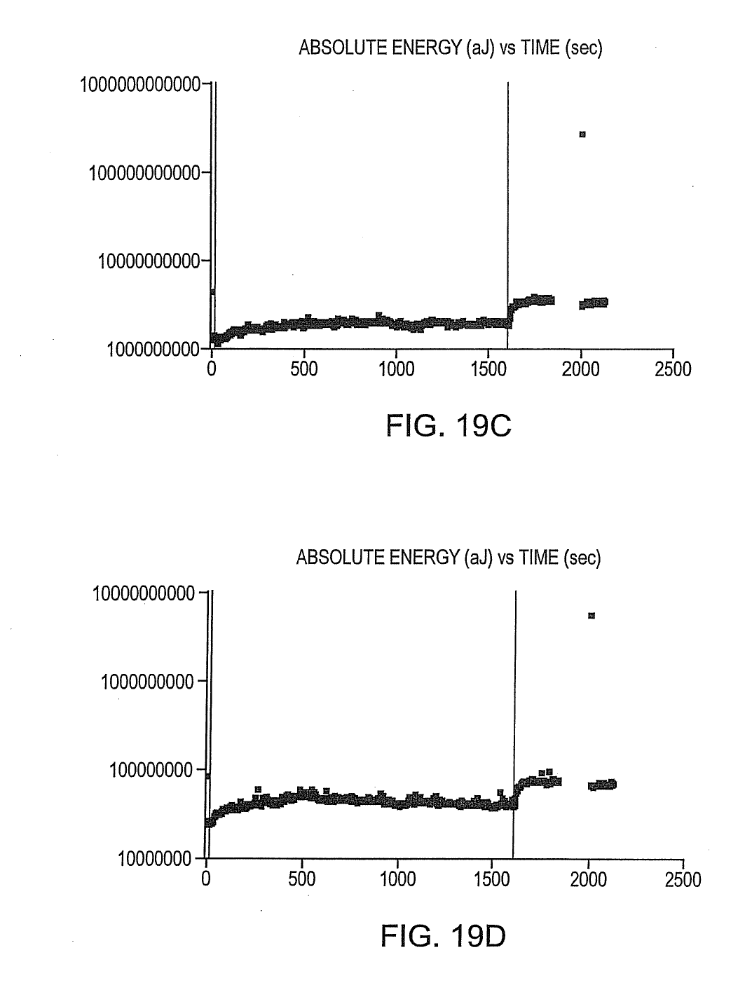

In Test 2, the air coal ratio FIG. 17A was held constant at 1.75 while the velocity FIG. 17B was changed from 90 to 110 feet per second. This test showed that the change in velocity resulted in an increase in energy which was exponential. FIGS. 18A-18D and 19A-19D correspond to measurements taken from sensors 1-4 where the locations of the sensors were not changed. The effect of the exponential increase which occurs when velocity changes is best seen in FIG. 19 where there is a jump up of the data when the velocity is increased. The vertical line in the screens of 19A-18D and 19A-19D shows the time of the increase in velocity which is approximately 12:25 PM as shown in FIGS. 17A and 17B.

This data taken with acoustic emission sensors as demonstrated by the EPRI testing provides knowledge of particle mass of air flow velocity (coal flow in a pipe). This shows that measurements taken at the intakes of the pulverizer (such as the first 90° bend) allows for an adequate understanding of individual feeder pipe conditions. Once the relative relationship between individual feeder pipe conditions is determined based upon AE emission sensing it is then possible to adjust coal air product in each pipe such as the 4 to 7 pipe outlets from a pulverizer. In order to achieve satisfactory furnace operation, the pipe flows must be equivalent and should be true within 10%.

In the tests made at EPRI and the installation at San Juan Generating Station (SJGS), the sensors were calibrated using the standard number two mechanical pencil break method established by Physical Acoustics Corporation. The threshold was set to 75 dB. In all cases, the impacts with the walls were recorded by integrating the number of hits in energy per unit of time.

### Control Systems

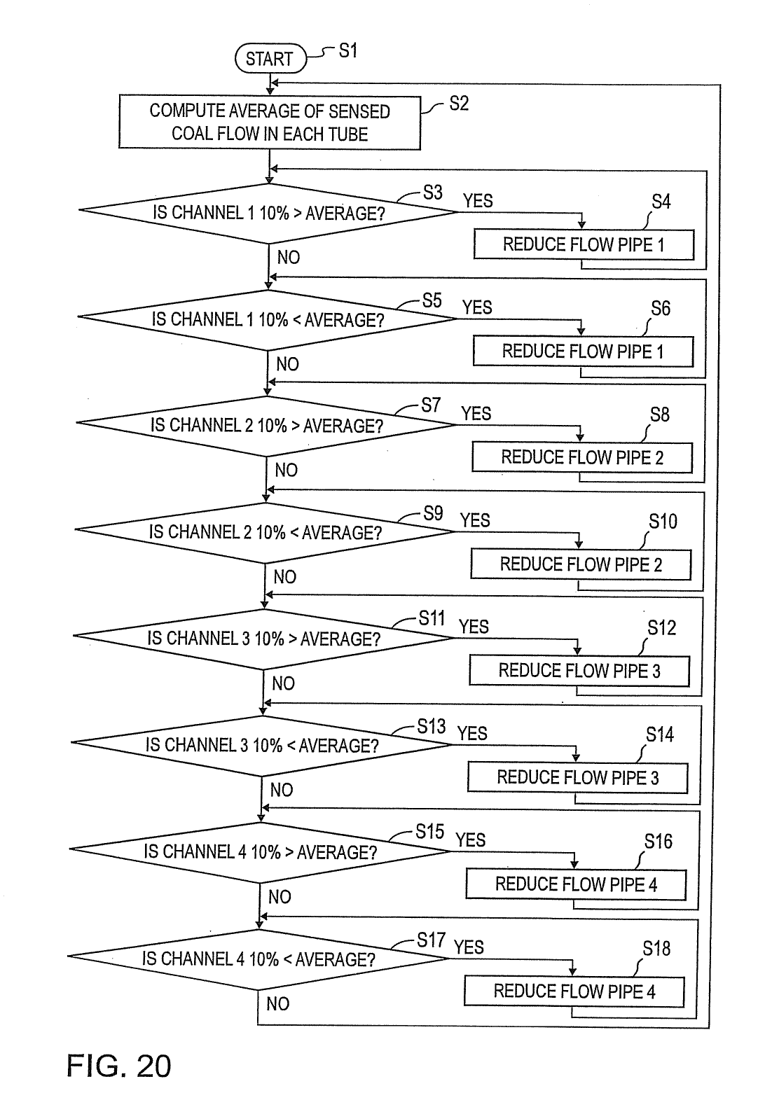

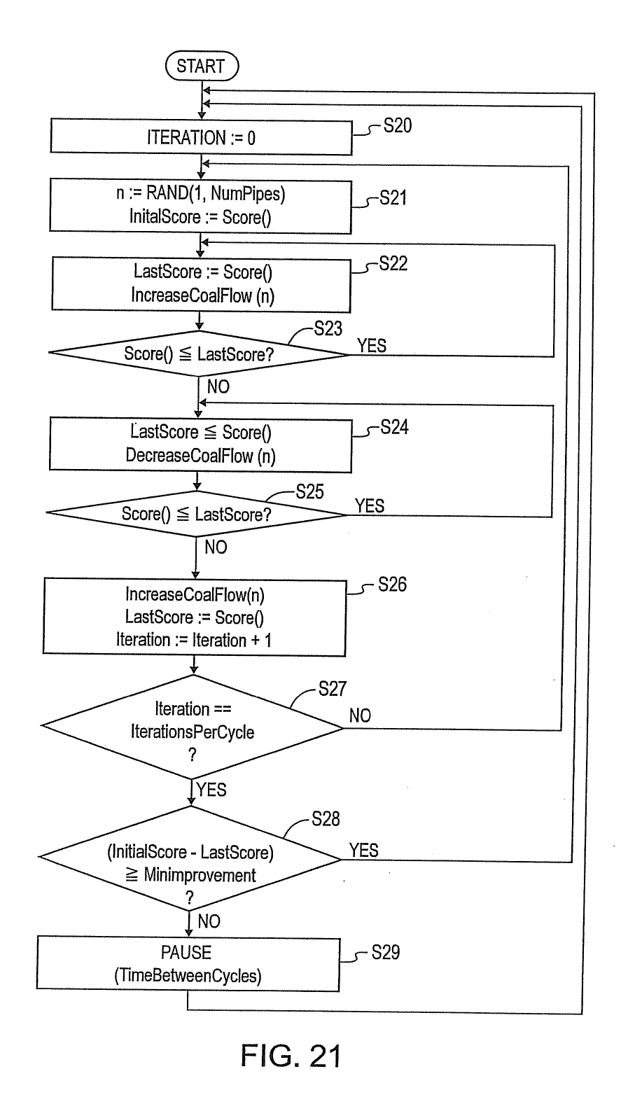

Detecting relative flow in pipes from a pulverizer can be utilized to balance the flow in the pipes by controlling flow with a coal flow modulator. FIG. 20 shows a control system for adjusting pipe flows to within ±10% of an average. When flow is with respect to other pipes the average is divided by two to make the difference between the pipes the limit. For instance, a ±5% difference from average will yield a 10% difference between the two. Since it may be desirable to control the flow of each pipe within 10% of an average, each detected coal pipe flow can be compared to the average and adjusted by an incremental amounts to approach the average. Step S1 is start. Step S2 is determination of an average of detected coal flow in 4 pipes from a pulverizer. At step S3 detected flow of pipe 1 is compared to the average. If the flow in pipe 1 is greater than 10% of the average, flow in pipe 1 is reduced at step S4. Upon reduction of the flow, pipe 1 is then again compared to the average. If it is determined that the flow in pipe 1 is not greater than 10% of the average, then control passes to step S5 where the flow in pipe 1 is compared to the average, and it is determined whether the flow in pipe 1 is 10% less than the average. If the flow is less than (yes), then pipe flow is increased at step S6 and control is then passed back to step S5 and when it is determined that the flow is not 10% less than the average, then control passes to step S7 where it is determined whether the flow in pipe 2 is 10% greater than the average. If it is (yes), then control passes to step S8 where the flow is decreased. When it is determined that the flow is not 10% greater (no), control then passes to step S9 where it is determined whether the flow in pipe 2 is less than the average. If it is determined that the flow is less than the average (yes), then at step S10, the flow in pipe 2 will be increased. When it is determined that the pipe flow is not less than 10% of the average then control passes to S11. In this manner, the flow in pipes 3 and 4 are compared to the average in steps S11 through S18. At the completion of step S18, control is passed back to start.

The control from steps S1 to S18 can then be repeated periodically whenever air/coal ratio is changed periodically, or when other operating parameters affect the output of a pulverizer.

In FIG. 21 there is shown a flow control loop diagram for fuel air tuning which uses plant operating parameter feedback. In the use of parameter feedback, a minimum emissions such as NOₓ particulate and CO from the power plant can be used. Also plant operating conditions such as power level and temperatures can be used. Other parameters or functions of parametric measurement can be selected by those skilled in the art of power plant operations. In the diagram of FIG. 21, the term “Score” refers to the weighted average of the emissions parameters being used as feedback for the control mechanism. “Score” is always an instantaneous value of the as used in this diagram, it is assumed for the purpose of the diagram that lower Scores are better and that the tuning cycle should stop when the improvement from a pass of adjusting pipes is less than a predetermined “MinImprovement” (See Step 28).

In FIG. 21, after start iteration is set to zero at step S20. In step S21, n is a random number where the numbers designate pipes from a pulverizer and initial Score is assigned the value of Score. In the case of a four pipe pulverizer, n can be 1 to 4. n is chosen at random, and not in sequence. At step S21, the initial Score is set equal to the instantaneous Score which is the instantaneous value at the time of setting. The object is to improve the initial Score during iterations.

At S22, a first iteration is begun with respect to the coal flow in pipe n (the random number from step S21). An incremental increase occurs at S22. When it is determined that the instantaneous Score is improved, it is an indication that improvement occurs with increase of coal flow. When Score is improved, control is passed back to step S22 for a further increase. When it is determined that the instantaneous Score is not further improved, at step S23, control passes to step S24. At step S24, there is an incremental decrease of the coal flow in pipe n. Again, if the core is improved (S25), a further incremental decrease is made by passing control to step S24. When it is determined that the Score is no longer improved at S25, control passes to step S26.

At S26, the increase coal function is repeated and coal flow is increased by an increment. The increase of coal flow is because the previous steps S24, S25 which means the flow was decreased by one too many increments. At S26, the variable “LastScore” is set to “Score.” The instantaneous value of Score is stored because it is used in the comparison step S28 as “LastScore.” Finally at S26 the iterations are increased by one because tuning of one pipe has just been completed. At S27 the number of iterations is compared to the predetermined number of iterations per cycle. A cycle is a completion of tuning the n pipes in a random order and may be a number such as 20 or 100.

Then the iterations are begun again when the cycle is not complete. The selection of pipes in a random order provides for control without the system being dependent upon a fixed order of pipe testing. Upon completion of the number of iterations in a cycle, at step S27, control passes to step S28 where (InitialScore-LastScore) is compared to MinImprovement. InitialScore is from S21. When there is improvement (InitialScore-LastScore), but it is not less than MinImprovement from s21, then the cycle will be repeated by passing of control from S28 back to S20. On the other hand, when there is no further improvement (InitialScore-LastScore) is less than MinImprovement, then control passes to S29. At S29 there is an appropriate pause in time taken between cycles. This pause in time may be in the order of several minutes to a time in the order of an hour or more. The pause is to allow the system to operate without continuous adjustment or modulation after the weighted average or “Score” is no longer improving.

At S21 there is a new random selection n=RAND[1,NumPipes] which may yield n different from n in step S20 when another iteration is started by passing control from S27 back to S21.

The terminology in FIG. 21 is as follows:
:= This denotes assignment. The value on the right is assigned to the variable on the left. For example, a :=b reads a is assigned the value of b.
<= This is the less-than-or-equal-to operator. It returns true if the value on its left is less than or equal to the value on its right and false otherwise.
>= This is the greater-than-or-equal-to operator. It returns true if the value on its left is greater than or equal to the value on its right and false otherwise.
== This is the equal-to operator. It returns true if the value on its left is equal to the value on its right and false otherwise.
Cycle: In terms of the diagram, a cycle is all the steps necessary to get from the Iteration :=0 step to the Pause (TimeBetweenCycles) step. All of the actual tuning takes place within a cycle.
Score: This is used to denote the result of the Score( ) function whose value we are attempting to minimize via this feedback algorithm.
Start: This denotes the entry point to the algorithm in the diagram.

An increment is a change of coal flow which can be sensed as an increment in acoustic emissions which is an increment of sensed energy in a roping coal flow. A power plant score is then adjusted in accordance with increments and relative coal flow and not as a measurement of absolute quantity of coal flow. Change by increments of flow in each of the pipes is by varying coal flow modulators which change the velocity of air in the pipe which changes the amount of coal when air/coal ratio is held constant.

While the invention has been described in conjunction with the specific exemplary embodiments thereof, it is evident that many alternatives, modifications, and variations will be apparent to those skilled in the art. Accordingly, embodiments of the invention as set forth herein are intended to be illustrative, not limiting. There are changes that may be made without departing from the spirit and scope of the invention.

1-2. (canceled)

3. A method of controlling relative coal flow in pipes from a pulverizer to a burner comprising the steps of:
calibrating acoustic emission (AB) sensors;
placing an acoustic emissions sensor at a same relative position on each pipe;
sensing vibrations of each pipe with a sensor;
calculating an average of sensed vibrations of each pipe;
comparing the average of the sensed vibrations to the sensed vibrations of each pipe; and
adjusting coal flow in the pipes to be within a predetermined percentage of the average.

4. The method in accordance with claim 3 further comprising placing an acoustic sensor at a bend on each pipe.

5. The method in accordance with claim 3 wherein sensed vibrations are produced by the energy of particles impacting walls of the pipes.

6. The method of claim 3 wherein the average is a moving average.

7-8. (canceled)

9-11. (canceled)

12. A method for sensing relative amplitude of acoustic emission (AE) vibrations produced by coal flow in a plurality of pipes comprising the steps of:
calibrating acoustic emission (AE) sensors with a predetermined acoustic emission and adjusting amplifiers associated with each sensor to have a same response to the predetermined acoustic emission;
placing a calibrated acoustic vibration sensor at a comparable position on each of the plurality of pipes;
sensing acoustic vibration of each pipe with a calibrated sensor;
comparing sensor outputs on different pipes to sense the relative amplitude of the acoustic vibrations.

13. The method in accordance with claim 12 wherein the position on each the pipes is approximately the same.

14. The method in accordance with claim 12 further comprising the step of placing the sensors on a section of pipe where the coal flow in the pipe is in a roping condition.

15. A method of providing a signal related to relative flow of coal particles in coal pipes comprising the steps of:
placing at least one acoustic emission (AE) sensor on an outside of a portion of first and second coal pipes having flowing particles impacting walls of the pipes;
detecting response of the at least one acoustic sensor to impacts while varying coal flow through the at least one pipe to acquire acoustic emission data for known coal flow rates, wherein the data is impacts per unit of time for a plurality of flow rates; and
correlating acoustic emission data of the impacts per unit of time and a measured flow rate with response of at least one acoustic emission sensor located on the first and second coal pipes to determine relative coal flow.

16. The method in accordance with claim 15 further comprising sensing energy of the impacts in each pipe.

17. A method providing a signal related to flow of coal particles in air flowing through a pipe from a pulverizer comprising in combination:
placing a single acoustic emission (AE) sensor at a position on a bend of the pipe;
using the acoustic sensor to detect collisions of the coal particles with the pipe at the bend;
filtering out signals from the detector to eliminate noise not related to collisions of the coal particles with the pipe;
processing filtered signals only from the single acoustic sensor to detect change of coal flow in the pipe.

18. The method in accordance with claim 17 further comprising using an acoustic sensor (AE) which is a vibration accelerometer.

19. The method in accordance with claim 17 wherein the filtering is a broadband filtering which allows detecting of frequencies between 100 Khz and 1 Mhz.

20. The method in accordance with claim 17 wherein the collisions produce radial mode impact vibrations and wherein the acoustic emission sensor detects radial mode impact vibrations.

21. The method in accordance with claim 17 further comprising the step of sensing the hits of particles against the wall per unit of time and integrating over time sensed hits.

22. The method in accordance with claim 17 further comprising placing the acoustic emission sensor an outside of the bend.
